(19) United States
(12) Patent Application Publication
(10) Pub. No.: US 2025/0150678 A1
(43) Pub. Date: May 8, 2025

(54) MEDIA SHARING AND COMMUNICATION SYSTEM

(71) Applicant: David A. TAYLOR, Sterling Heights, MI (US)

(72) Inventor: David A. TAYLOR, Sterling Heights, MI (US)

(21) Appl. No.: 19/016,577

(22) Filed: Jan. 10, 2025

Related U.S. Application Data
(63) Continuation-in-part of application No. 18/669,817, filed on May 21, 2024.
Application No. 18/669,817 is a continuation-in-part of application No. 18/652,119, filed on May 1, 2024.
Application No. 18/652,119 is a continuation-in-part of application No. 17/947,336, filed on Sep. 19, 2022, now Pat. No. 12,177,525.
Application No. 17/947,336 is a continuation-in-part of application No. 17/108,306, filed on Dec. 1, 2020, now Pat. No. 11,457,284.
Application No. 17/108,306 is a continuation-in-part of application No. 17/087,794, filed on Nov. 3, 2020, now Pat. No. 11,456,982.
Application No. 17/087,794 is a continuation-in-part of application No. 16/923,699, filed on Jul. 8, 2020, now Pat. No. 11,483,624.
Application No. 16/923,699 is a continuation-in-part of application No. 16/882,512, filed on May 24, 2020, now Pat. No. 11,483,432.
Application No. 16/882,512 is a continuation-in-part of application No. 16/832,370, filed on Mar. 27, 2020, now Pat. No. 11,582,526.
Application No. 16/832,370 is a continuation-in-part of application No. 16/683,347, filed on Nov. 14, 2019, now Pat. No. 10,715,872.
Application No. 16/683,347 is a continuation-in-part of application No. 16/032,612, filed on Jul. 11, 2018, now Pat. No. 10,694,255.
Application No. 16/032,612 is a continuation-in-part of application No. 13/937,001, filed on Jul. 8, 2013, now Pat. No. 10,368,122.
(60) Provisional application No. 61/773,518, filed on Mar. 6, 2013.

(51) Int. Cl. H04N 21/478; G06Q 30/0601; H04N 21/414; H04N 21/433

(52) U.S. Cl. CPC H04N 21/47815; G06Q 30/0641; H04N 21/41407; H04N 21/4334

(57) ABSTRACT

A media and shopping interface for purchasing items on media, including a user system having a user interface displaying items for purchase that is accessible through a user initiating a connection between a mobile device and a media screen that pushes data of items for purchase or available bets to the mobile device, wherein the user interface is remote from the media being shown, the user system including software stored on non-transitory computer readable media that recognizes and tags purchasable items in the media and the user system including artificial intelligence integrated therein, wherein the user system displays items for purchase, the user system including a one-click purchase function allowing for secure and efficient purchases. A method of shopping on media. A method of integrating the media and shopping interface with an external service provider. A method of collecting and analyzing advertising data.

### BACKGROUND OF THE INVENTION

### 1. Technical Field

The present invention relates to generally to media sharing and communication systems and methods of providing the same.

### 2. Background Art

Individuals having common bonds, both men and women, congregate together to watch events such as sports, theater, or otherwise. In one particular aspect, it is common for individuals to watch television programming including movies, sports, politics, or otherwise. This may occur in a public setting, such as bars, or in a private setting, such as one's home. During these programming events, individuals engage in discussions, exchange of ideas or beliefs, cheering or even badgering one another.

With the expansion in relationships between individuals, it is not always possible for individuals to participate in viewing events or programming together. This is particularly the case after individuals separate over time, such as after military service, college, or otherwise. However, recently it has become more common for individuals to maintain long distance relationships with one another. To this extent, various internet service providers have offered networking and communication systems between individuals. They provide the ability to send public and private messages to others in their networking group. They also provide the ability to share profiles and preferences with one another so as to exchange information. Examples of such networking systems include FACEBOOK®, LINKEDIN®, TWITTER®, or otherwise.

However, while these and other networking means have provided some means for individuals to maintain contact, they do not effectively replace the ability for individuals to interact with one another, particularly when it comes to events and more particularly with television programming.

In view of the foregoing, there is a need for systems and methods to allow individuals to continue to enjoy events and programming together, without having to be at the same location. This allows for expanded networking in different aspects than before.

### SUMMARY OF THE INVENTION

The present invention provides for a media and shopping interface for purchasing items on media, including a user system having a user interface displaying items for purchase that is accessible through a user initiating a connection between a mobile device and a media screen that pushes data of items for purchase or available bets to the mobile device, the user system including software stored on non-transitory computer readable media that recognizes and tags purchasable items in the media and the user system including artificial intelligence (AI) integrated therein, wherein the user system displays items for purchase, the user system including a one-click purchase function allowing for secure and efficient purchases.

The present invention also provides for a method of shopping on media, including the steps of a user initiating a connection between a mobile device of a user system having a user interface and a media screen that pushes data of items for purchase or available bets to the mobile device, artificial intelligence (AI) integrated in the system retrieving images based on user queries and software recognizing and assigning functional tags to purchasable items in the media, the functional tags not being visually displayed on a screen during media playback, the user selecting an item in the media by clicking on it, the user accessing a one-click purchase function on the screen, and the user purchasing the item seamlessly.

The present invention also provides for a method of integrating the media and shopping interface with an external service provider, by AI integrated in the media and shopping interface gathering integration requirements for the external service provider, performing AI model development, performing tool development and integration of the media shopping interface with the external service provider, performing testing and validation, and performing feedback and iteration.

The present invention provides for a method of shopping on media by a user engaging in media playback on a user system's interface, software recognizing and assigning functional tags to purchasable items in the media, the user selecting an item in the media wherein interaction with the item does not disrupt or alter ongoing media playback, the user accessing a one-click purchase function on the screen, and the user purchasing the item seamlessly without viewing a third party seller's webpage using stored payment and address information securely stored on non-transitory computer-readable media within the user system.

The present invention provides for a method of collecting and analyzing advertising data, by a user interacting with an advertisement on media (and preferably streaming media) within the user system, the user system collecting data relating to the user's interaction with the advertisement and storing the data on non-transitory computer readable media, AI on the user system analyzing the collected data, and the user system providing the analyzed data to a third party.

### DESCRIPTION OF THE DRAWINGS

Other advantages of the present invention are readily appreciated as the same becomes better understood by reference to the following detailed description when considered in connection with the accompanying drawings wherein:

FIG. 1 illustrate a schematic view of a media sharing and communication system according to the teachings of the present invention;

FIG. 2 illustrates a schematic view of another media sharing and communication system according to the teachings of the present invention;

FIG. 3 illustrates a schematic view of another media sharing and communication system according to the teachings of the present invention;

FIG. 4 illustrates a schematic view of another media sharing and communication system according to the teachings of the present invention;

FIG. 5 illustrates a screen-shot of an exemplary user interface according to the teachings of the present invention;

FIG. 6 is a diagram of the system architecture; and

FIGS. 7A-71 show screenshots of product recognition within the store section, FIG. 7A shows an outfit, FIG. 7B shows recognition of pieces of an outfit, FIG. 7C shows a coat, FIG. 7D shows a bag, FIG. 7E shows a shoe, FIG. 7F shows a shoe, FIG. 7G shows products found in the image of FIG. 7H, and FIG. 7I shows suggested products.

### DETAILED DESCRIPTION OF THE INVENTION

The present invention generally provides systems and methods for sharing and exchanging media between individuals as well as shopping on media with a media sharing and communication system 10, shown in the FIGURES. The exchange of media can be based on known interests of others.

“Individual” as defined herein, refers to an individual user of media, and not a media content provider or company.

“Media” as used herein, refers preferably to a short portion of media, or a clip i.e., less than a whole video, movie, television show, song, commercial, etc. However, full portions of media can also be shared. Also, screenshots of media can be shared. The portion of media can be any length of time, such as 5 seconds, 10 seconds, 25 seconds, 1 minute, 2 minutes, 5 minutes, or other lengths. Some media are already divided into blocks defining particular scenes, such as in 10 second blocks or other lengths. The preset blocks of media can also be shared, and do not necessarily need to be recorded to be shared.

The media can also be an online game, and users can record portions of the game they are playing, allowing other users to see highlights, records, achievements, or in general plays they have made. The online game can be played on systems such as Xbox, PlayStation, Nintendo DS, or other web-based games through the Internet.

Advancements through the features of the present invention provide a TUBEMAIL™ TUBESHARE™, YOUSHARE™, communication system that allows individual users, who share the same cable or satellite provider, the ability to record and share portions or full episodes of sporting events, movies, shows, or otherwise along with messages regarding the media.

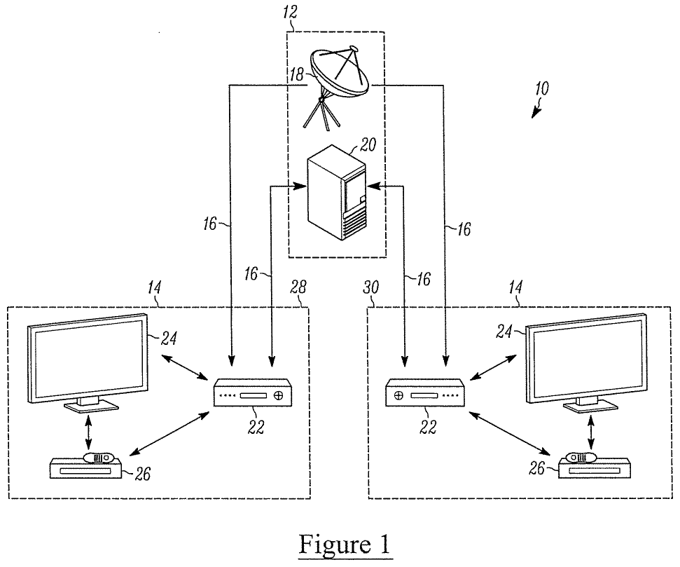

Referring to FIG. 1, an exemplary embodiment of a media sharing and communication system 10 is shown. The system 10 includes a media content provider 12 configured to provide media content to a plurality of user systems 14 over one or more networks 16. The system 10 includes a transmitter 18 configured to transmit media, particularly media programming, to the user systems 14 over the one or more networks 16. The system 10 further includes a receiver 20 configured to receive media, or media information including identification information, from the user systems 14, over the one or more networks 16. The plurality of user systems 14 are configured to receive media, such as television programming, from the media content provider 12. In one exemplary embodiment, the user systems 14 include a user transmitter/receiver 22, in communication with the media content provider, a display screen 24 for viewing media content received by the user transmitter/receiver, and in one particular exemplary embodiment a digital recording device 26 for recording digital information received by the transmitter/receiver 18. In one particular configuration, the user transmitter/receiver 22 is further configured for transmitting data stored by the digital recording device 26.

In one exemplary mode of operation, digital media is transmitted or streamed by the media content provider 12 to the plurality of user systems 14. The media transmitted by the media content provider 12 may comprise any media transmitted by a network including programming shows, movies, sporting events, or otherwise. The transmitted media is received by the user systems 14 through the one or more networks 16. The media received by the user transmitter/receiver 22 is further transmitted to the display screen 24 for viewing. During viewing, once the individual user of the user system 14 determines they wish to share media content, the digital recording device 26 is activated to record the desired media or record information pertaining to the desired media. The media can also be stored and saved on non-transitory computer readable medium on the digital recording device 26 for sharing at a later time by the user or for the user's own personal reasons such as rewatching media or posting to their profile or social media to promote dialogues about certain scenes or products (i.e., the user can post or share media to their social media page or profile outside of the system such as FACEBOOK® or INSTAGRAM®). The digital recording device 26 can also copy the media for storage for a limited time instead of recording. The individual user of the user system 14 generates a message (which can be a text message, a voice commentary message, information related to the location of the media, or combinations thereof) and the recorded media or record information pertaining to the desired media along with the message is then transmitted to another user system 14 (i.e., a second user system 14), via the network 16, through the user transmitter/receiver 22. It should be understood that text messages can include emojis. Messages can also include image files, such as memes, gifs, stickers, or other files. Dissemination of media from one user system 14 to another user system 14 may be based upon selection by an individual user of the first user system 14, based upon user profile set up by an individual user of the first or second user system 14, or otherwise. In other words, the media can be selectively distributed to individual users based on their preferences, including an indication of desired media content. Once the recorded media or media information is received by the second user system 14, the second individual user selectively reviews the message and views the media. In case the first individual user does not send a message along with the portion of media, the second individual user can initiate dialogue with the first individual user and send a message to the first individual user. For example, if the first individual user sends a clip from a TV show without a message, and the second individual user is confused as to why they received the clip, they can send a message to the first individual user to ask them why the clip was sent. The first individual user can send messages either to a second individual user alone, or to a group of individual users that the first individual user can select to share the message with. When sent to a group, this functions as a group chat.

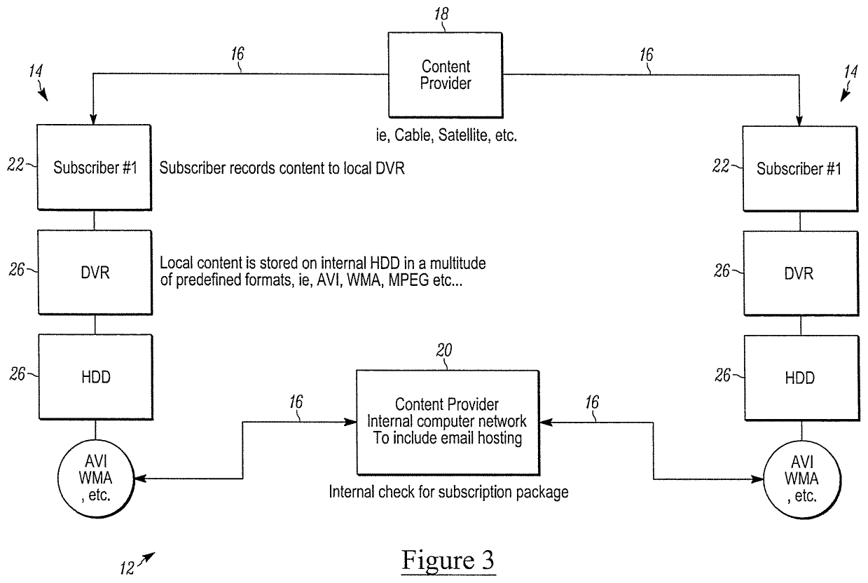

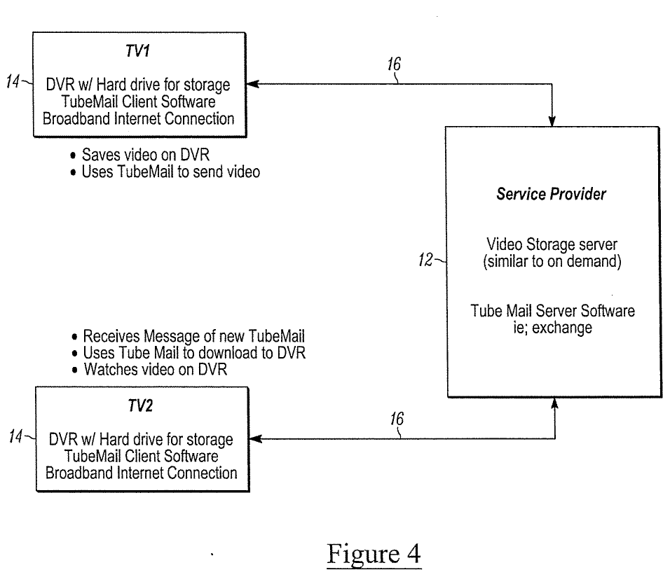

In greater detail, with reference to FIGS. 1-4, the media content provider 12 is configured for disseminating media to a plurality of user systems 14. In one exemplary embodiment, the media content provider 12 comprises a cable television provider, satellite television provider, online movie or other media provider, a media provider through applications on a smartphone or tablet, computer, or otherwise. The media content provider 12 provides assortment of media including audio/visual media, identification information or otherwise. The media provides one or more, or plurality of programming for the user systems 14. Examples of programming available through the media, without limitation, includes movies, network programming, sporting events, concerts, online games, or otherwise. The media disseminated to the user systems 14 may be streamed through or stored on local hard drive of the media content provider 12 or be accessible through a cloud.

The transmitter 18 of the media content provider 12 is configured to disseminate media to a plurality of user systems 14 over one or more networks 16. In one configuration, the network comprises a hardwired network, such as a cable network extending from the media content provider 12 to the user systems 14. In another configuration, the network comprises or includes a wireless network configured for broadcasting signals through radio waves or otherwise. In the latter configuration the media content provider 12 includes a satellite dish or other means for broadcasting media. It is contemplated that the media disseminated from the media content provider 12 may be streamed through the media content provider or stored on one or more digital recording device. Any user transmitter 18 or receiver 20 can include wireless communication links for receiving media and media content providers 12 can disseminate media through wireless communication links.

The receiver 20 of the media content provider is configured to receive information from the user systems 14. In one configuration, the receiver 20 records data transmitted by the user systems including media, program information, both or otherwise. Accordingly, in view of the many potential user systems 14, it is contemplated that the receiver 20 includes many data storage devices. In another configuration, the receiver 20 is further configured for transmitting the received or recorded media to another user system 14, according to a request by the originating user system 14.

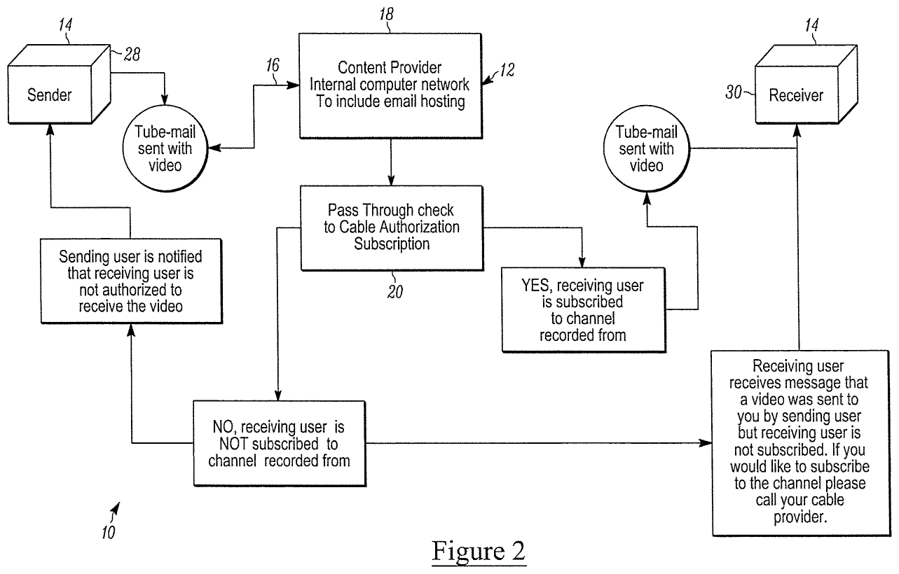

In one particular exemplary embodiment, referring to FIG. 2, the receiver 20 is configured with suitable software for reviewing media transmitted by a user system. In this configuration, it is possible for the receiver 20 to review the identification information of the media transmitted by a first user system 28 and confirm that a designated second user system 30 is authorized to receive the media. In this configuration, the receiver 20 confirms that the media transmitted by the first user system 28 is viewable by the second user system 30 through the viewing package held by the second user system. For example, should the first user system 28 transmit media from a first channel the receiver 20 confirms that the second user system 30 is authorized to view media on the first channel. Should the programming subscribed by the second user system 30 include the first channel then the second user system is authorized to receive and view the media along with any communication attached therewith. Should the programming purchased by the second user system 30 not include the first channel then the second user system is notified that media could not be received due to programming configuration subscribed by the second user. Also, the first user system 28 is notified that the second user system 30 is not authorized to receive the media due to programming subscription of the second user system. The authorization of the second user system 30 can also be automatic or not needed if all users are subscribed to a particular streaming service or channel that automatically allows them access to content therein.

Referring again to FIG. 1, the user system 14, e.g., first user system 28, second user system 30 or otherwise, include the user transmitter/receiver 22, which is configured to receive media from the media content provider 12 and in one particular exemplary embodiment transmit media and/or communication to the media content provider 12 and another user system 14. In one exemplary embodiment, the user transmitter/receiver 22 is similar or includes a cable box, satellite receiver or similar devise commonly used to receive broadcasted digital programming. It should be appreciated that the transmitter/receiver 22 may comprise a single unit or several units. The user transmitter/receiver 22 can also be a suitable mechanism for receiving data within a smartphone or tablet.

The user system 14 further include display screen 24 configured to display media received by the user transmitter/receiver 22. The display screen comprises any suitable display screen including standard definition televisions, high definition televisions, monitors or otherwise. The display screen 24 is in communication with the transmitter/receiver 22 through suitable connecting cables or otherwise. The user systems 14 further includes digital recording device 26 configured to record media received by the user transmitter/receiver 22. Examples of suitable digital recording devices 26 includes DVRs or otherwise. The digital recording device 26 is in communication with the transmitter/receiver 22 through suitable connecting cables or otherwise.

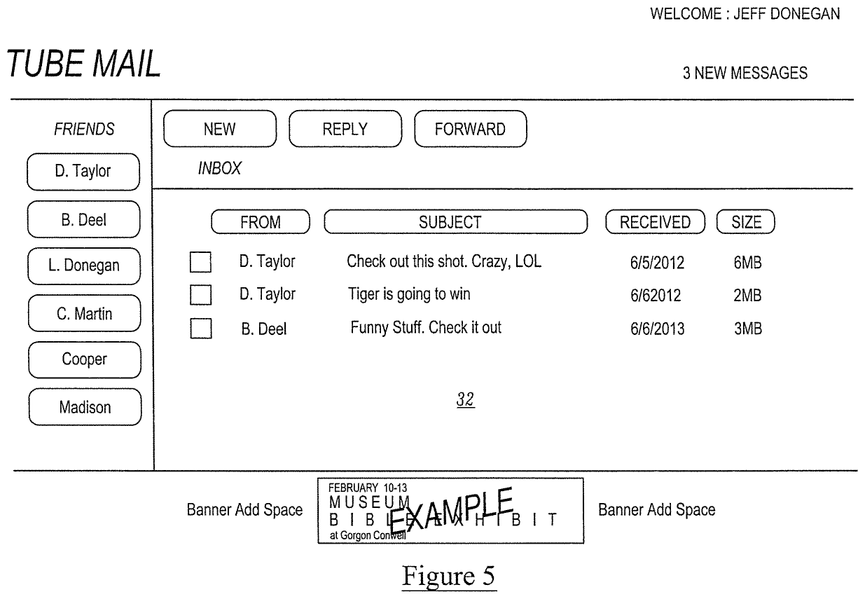

Referring to FIGS. 1 and 5, the user systems 14 further include suitable software for generation of a user interface 32 that is useable with a remote keypad, mouse and/or other user interface devices (i.e., smart/mobile devices, smartphones, tablets, or other portable devices). A smartphone or tablet can also be used as a remote control (to allow for easier messaging and use of emojis and general use of the user interface 32) in combination with a television or larger computer screen such as through the use of BLUETOOTH® or Wi-Fi or through the use of near field communication (NFC) technology. Most generally, the user initiates a connection between a mobile device and a media screen or place showing items for purchase/bets for placing. With NFC, a smart/mobile device can be held within range of a television or other media display screen (approximately 10 centimeters or less) and allows radio communication at a frequency of 13.56 MHz between the smartphone and media display screen. Both the smart device and media display screen can be active devices in order to transmit and receive data. A smart device can be tapped to a media screen with NFC technology to pair with the media screen, i.e., an NFC connection can be initiated between the mobile device and a media screen. This allows the user system 14 to be used in public places showing media such as in a bar and provides full functionality of the user system 14 with various options such as shopping and betting as further described below. The user system 14 can also be used with any remote device (including smartphones) having an optical mechanism (such as an infrared light emitter, or a white light emitter, or photo diodes) that can recognize that certain areas of the screen are targets for performing a function (messaging, shopping, betting, etc.). This can be useful when a user is in a bar or public location and wants to purchase/bet from a media broadcast (further described below). The smart/mobile device can also mirror anything that is displayed on a television to make any operation of the system easier for the user. In one exemplary embodiment, the suitable software for generating the user interface 32 is stored on a memory device of the user transmitter/receiver 22.

In the configuration shown in FIG. 5, the user interface 32 provides means for composing messages (whether text, video, or voice) and attaching media segments, e.g., audio, video and/or identification information, to the composed message. A quick share button can be included in the user interface 32 that provides instant recording of media with options of length of time of 5 seconds, 10 seconds, 15 seconds, 30 seconds, 1 minute, 5 minutes, as well as any other desired length of time. The completed communication is then sendable to other user systems 14. An instant messaging exchange can be located across the bottom of the user interface 32. In the configuration shown, the user interface 32 includes a ‘FRIENDS’ section indicating users of other user systems 14. The user interface 32 further includes ‘NEW’, ‘REPLY’ and ‘FORWARD’ icons for creating, responding and forwarding communications, which may include media. The user interface 32 further includes ‘INBOX’ section listing communication received from other user systems 14 including ‘FROM’, communication or media ‘SUBJECT’, date ‘RECIEVED’, and file ‘SIZE’ In one exemplary embodiment, the user interface 32 includes ‘Banner Add Space’ for displaying relevant marketing or advertising to the user of the user system, which may be based upon a user profile (including age, gender, location, interests such as favorite television shows, actresses or actors, sport teams, soap operas, musician, band, celebrity commercials or otherwise), transmitted or received media and/or communication, or otherwise. The user interface 32 can provide tutorial pop-ups that show how to use any portion of the user system 14, which can be accessed quickly through a clickable icon or other mechanism on the user interface 32 any time that the user requires further information about the system processes.

The user interface 32 can also include a store section wherein users can shop for products or services directly from their user system 14 seamlessly while interacting with media. The store section can be easily accessible through a shop button or icon on the user interface 32, or through texting a code or scanning a QR code with a mobile device (smartphone, tablet, or other device), by pointing a smart device at a screen playing media that has BLUETOOTH® or Wi-Fi capabilities, or by placing a smart/mobile device within range of a media screen with NFC technology (i.e. initiating connection between the smart/mobile device and media screen with NFC technology such as by tapping or pairing a smart/mobile device to a media screen), further described below. The shop button or icon can remain on the screen of the user interface 32 at all times that can be toggled by the user to shop while the media is playing or alternatively the shop button or icon can pop up on the screen when the media is paused. For example, when the media is an online game, the user can toggle purchasing by pausing the game or toggling a purchasing icon on the screen that pauses the game, or alternatively the game can run in the background while a purchase is quickly and seamlessly made with one-click purchasing. A banner or separate section can also run along the bottom of the user interface 32 or at the side where products or services can be displayed while playing media. The store section can include products/services that are directly advertised to the user as above, or products that may be of interest to the user based on their user profile (i.e., targeted to the user based on things that they like or are following their profile). The store section can include links to products/services on outside websites, such that when the user clicks on the item, they are directed to an outside website to complete the purchase. The store section can also receive meta data (or other data tagged with information) from media that the user is watching that generates links to products shown in the media so that the user can purchase the products. The media can automatically push this data to the user system 14. Items can be tagged with a software program similar to facial recognition software used by FACEBOOK®. Any item within the media can be recognized with the software program and identified as an item available for purchase (such as clothing, jewelry, furniture, décor, makeup and beauty items, toys, and other household items) and that item can be located on a website or store for purchase and the price of the item can be identified. The software program can analyze images within the media for pixel values and gradients to compare to images of items available for sale in order to correctly identify the items. It should be understood that the tags are functional and are not visually displayed on a screen during media playback, but rather function as markers, facilitating subsequent actions by the user. The images of items can be tagged with URLs and the user can click on the tag and be directed to a shop to purchase the item. Any of the functions described for the store section can also apply for the more specific betting modules or food ordering modules described below. It should also be understood that the user can select an item for purchase by other methods than clicking, such as dragging and dropping an item into a shopping cart, or circling the item with their finger or stylus on a touchscreen, or touching the item with a finger or stylus on a touchscreen. If the user is not directed to a separate webpage, it should be understood that purchases with the one-click purchasing allow the user to order from a seller (i.e., a third party such as Amazon that is providing the item) seamlessly without viewing the seller's webpage itself as well as without the need for a separate device that completes a transaction. Purchases can also be seamless within the system with one-click purchasing when merchandise/items are directly loaded for sale on the system (i.e., the system itself becomes the store without the need for a third-party seller).

Purchasable items can be identified with a logo or icon near the item (which can pop up when a mouse/remote control is moved over the item), or a highlight around the item. The store section can generate a QR code on the user interface 32 that can be scanned by the user's mobile device to show items available for purchase in the media. The QR code can be located anywhere suitable on the user interface 32, such as in a corner of the media playing, on a banner or bar, or it can be generated when the media is paused. The user can purchase products linked with the QR code directly on their mobile device (such as a smartphone or tablet).

The store section can also allow for users to purchase songs/music that they hear on media and songs can be tagged in the same manner as physical products. The songs can be downloaded individually as mp3 files or other audio files, or the user can purchase an entire album that the song is from. The songs can be synced or downloaded directly to the user's account or to other music platforms such as Apple Music or TIDAL. Any sports team or sporting event can also sell tickets directly to the user such as by advertising or while the user is watching a game. For example, the tickets can be for football (NFL), basketball (NBA), baseball (MLB), hockey (NHL), soccer, horse racing, car racing (NASCAR), university sports (NCAA), local teams, Olympic events, or international events.

With services, if a company with a service has an ad, the user can pause the media and click on a link, click on the button that remains on the screen, scan the QR code, or text a number to make an appointment for that service, such as for beauty services, haircuts, auto repair services, home repair services, healthcare services, or legal services. Any intake forms can be obtained by the user, filled out, and submitted to the company providing the service with the store section. For example, for legal services in order to set up a meeting with an attorney, the user can set up an interview with an attorney, answer preliminary questions, and submit evidence.

For example, if the user is watching “The View,” and they like the reading glasses that a co-host is wearing, a link can be generated for those glasses that the user can click on and buy the glasses. The user can pause the media that they are viewing (whether by operating a remote control, mouse, or touchscreen), and options of items for purchase can be presented on the screen either automatically (and include an indication that the item is for sale, such as a graphic display or icon with the name of the item and its price and/or source) or when the user clicks on or moves a mouse over a certain item. This allows the user to browse and select items without any disruption to the media, and the user can conveniently navigate through the displayed items and select an item they wish to purchase. Every item can be displayed for sale in the scene to the user or a single item that the user selects from the display. Users can also gift products to other users in the system or other individuals outside of the system. For example, users can gift a streaming package or digital gift cards to other users. Gift cards can be added to the other user's user profile for purchasing media content or other products that they desire. Users can also gift products (such as those advertised based on the other user's profile, or listed on a “Gift Me” section of the user's profile that is viewable to other users in which the user has liked or selected a particular item that they are interested in having purchased for them) and have them shipped to another user. Users can also view any products for sale in a 360 degree view (or 3D) such that the user can select or click on the product and move the product around in 360 degrees, allowing the user to see the product from all sides.

Users can also list their own products for sale in the store section to other users, as well as advertise their products to other users and upload their own advertisements or commercials.

Users can store their payment (credit card/debit card/banking) information in their profile, along with their address on non-transitory computer-readable media to make transactions within the user system 14 easy, quick, and secure and without the need for repetitive data entry during each transaction and without the need for a separate device to complete a transaction or purchase. Users can also have existing payment information linked or synced to their account that stores a credit card or debit card, such as with Apple Pay, PAYPAL®, Google Wallet, Google Pay, Stripe, or a remote wallet associated with a website (such as Fan Duel, etc.) If the user does not complete a transaction on an outside website, users can add items to a shopping cart within the user system 14 and check out with their payment information to have their items delivered. In general, when the user pauses the media, moves a curser on a remote control, or touches a screen on the user system 14, accesses the store section through a text or QR code on a mobile device, or places their smart device within range of a media screen with NFC technology capabilities (i.e. initiating a connection between the smart/mobile device and media screen with NFC technology such as by tapping or pairing a smart/mobile device to a media screen), options can pop up on the user interface 32 for recording, sharing, purchasing, betting, or gifting (i.e. icons can pop up with choices of actions). For screens that are not touch or curser activated, the icons can remain on the screen at all times. This allows the user to easily select an option and proceed with what they want to do. The user can click on the item they want to purchase and it can be added to a shopping cart, or alternatively drag and drop an item into a shopping cart, circle the item on a touchscreen, or touch (i.e., tap) the item on a touchscreen, the payment information can be attached to the user's account and they can purchase the item seamlessly without exiting the viewing platform and then the transaction can be closed. With touchscreens, a user can circle or tap a desired item or betting odd to select the item. This essentially provides a one-click function for shopping. A one-click function icon can appear on the screen of the user interface 32 after an item or items are selected for purchase, which the user can toggle to seamlessly proceed with the purchase of the item. The one-click function can be toggled as well through double-clicking a button on a smartphone, activating facial recognition, entering a passcode, using a touch identification button, or combinations thereof. While checking out, any error messages can be displayed in-context next to any input fields that are the cause of the error and instructions for resolving the error can be displayed to the user.

The present invention provides for a method of shopping on media by a user engaging in media playback on a user system's interface 32, software recognizing and assigning functional tags to purchasable items in the media, the user selecting an item in the media wherein interaction with the item does not disrupt or alter ongoing media playback, the user accessing a one-click purchase function on the screen, and the user purchasing the item seamlessly without viewing a third party seller's webpage using stored payment and address information securely stored on non-transitory computer-readable media within the user system 14.

The system can also include push notifications that allow parental control approval to protect against unapproved purchases. The push notifications can be sent to an account holder of a payment method when a transaction is attempted. Children or other individuals can have a user profile that a payment method is attached to. The account holder for the payment method can be required to approve purchases made using their method of purchase, such as confirming or denying the purchase.

Companies can locate customers (users) for merchandise sales based on their interests. Artificial intelligence on the user system 14 can collect data based on user activity on the user system 14 and this can be used to target users to send advertisements and promotions for one click check out. For example, the NFL may want to sell more Mahomes jerseys. The system of the present invention can locate users with this interest and advertise to them. Companies/broadcasters/content owners/advertisers can also load certain merchandise/items that are available during a broadcast of media onto the system. For example, during an NFL game of Bears versus Lions, the NFL can make the jerseys of players playing in that game available so upon pressing pause or tapping a touchscreen a user can select the jersey they desire and check out seamlessly with one click purchasing. Companies can also partner with the system and application to promote their merchandise/products instead of merchandise/products of a competitor. For example, a user is watching a DIY show and they want to buy a door. Home Depot can partner with the system so that the user is automatically directed to doors that Home Depot is selling instead of doors that Lowe's is selling. Any items can be preloaded onto the media playing on the system for purchase including food, tickets to events, gambling lines, services, etc.

The system can also in general collect any type of data generated by users, with or without the use of AI. For example, the system can collect data regarding media shares, purchases, food orders, bets, or any other relevant data.

Therefore, the present invention also provides for a method of shopping and promoting products on media, by a user playing media and accessing a store section on a user system 14 having a user interface 32, software recognizing and assigning functional tags to purchasable items in the media, the functional tags not being visually displayed on a screen during media playback, the items being promoted by a company that is partnered with the user system 14 instead of a competitor, the user selecting an item in the media for purchase, the user accessing a one-click purchase function in the user interface 32, and the user purchasing the item seamlessly. This method can also include any of the other steps or details described herein. This method can also be used with the betting module to allow a user to place bets (i.e., the item for purchase can be a bet).

The system can further allow for geo tag purchases that allow exclusive rights to unlock sales for merchandise based on a user's location. For example, an artist can move merchandise to attendees without them having to stand in line to purchase. Simply because the attendees are in the venue they can make purchases based off their geographical location.

In one example with the store section, a user is watching TV and sees a tie that George Clooney is wearing, the user can pause the screen, the option to record, share, or purchase pops up on the screen, the user can select purchase for any item that is tagged for purchase such as the tie, the item goes into their shopping cart, and having payment information attached to the user account allows the user to purchase or gift the tie that they want without exiting the viewing platform. In another example, a child is watching a DISNEY® movie and their parent hears them ask for a Princess Jasmine costume seen in the movie. The parent can pause the screen, select the costume, and purchase it without changing the channel or having to search on another market/platform.

Presently, when a person enters a common space such as a bar, restaurant, or friend's home to watch media broadcast or streamed, they need to connect to a website or go through a QR code in order to make a purchase or bet. This takes time, can be multi-step, and awkward. The present invention provides a simpler way to purchase and/or bet from common spaces.

With the present invention, when a user enters an establishment such as a bar showing sporting events or is watching media on a television (at their home or another person's home), the media playing/broadcaster/streaming service can provide/display a code to text or a QR code for scanning that is unique to that media program/channel allowing the user to access the user interface 32 from their mobile device (smartphone, tablet, etc.) such as through a website or application. The mobile device is remote from the media being shown (i.e., the media is being shown on a television/screen that is not part of the user interface 32 or mobile device). The mobile device can also use the establishment's Wi-Fi or BLUETOOTH® in connecting with media or the establishment's website or use NFC technology when placed within range of a media screen. The text code can be sent through a user's mobile device or scanning a QR code with a camera on the user's mobile device can generate a link to a website associated with the user interface 32. A QR code is essentially a barcode that can be read to convert it to a URL for a website or launch an application. This can be beneficial when many people are watching the same media and the user does not have access to the television or device that is streaming the media and/or does not want to disturb other people in order to purchase items or make bets. All of the items in the media are listed in the shopping section of the user interface 32 in real time as shown in the media and the user can select an item or service for purchase, order food, or place a bet. Items can be listed in drop down menus for selecting the source of goods or services, such as jerseys, tacos, etc. This technology avoids the awkwardness of trying to match and/or pair a smartphone camera to a screen showing a QR code. The present invention allows any item presented on broadcast or streamed content to be available to users for purchase within seconds. Ordering can go through a distributor (such as Amazon), directly from the source (such as Taco Bell), or directly from a casino (such as FanDuel or MGM).

For example, an NFL game has a code showing on the lower corner of the television screen “7245”. The user can text the number, and they are sent to the user interface 32 where all items available for purchase on the current screen can easily be selected for a one-click check out. If the Lions and Bears are playing, the NFL can include all merchandise associated with those two teams readily available for purchase through the code provided on the screen displaying the game. No search is required for the user. In a bar with multiple televisions each playing different games or media, each game can show its own text code/QR code.

Furthermore, each unique establishment is able to purchase rights to make the number to text or QR code unique to their establishment, i.e., the establishment can be provided with their own unique text code or QR code. This allows the establishment the opportunity to integrate with the user interface 32 in order to offer their own items unique to their location or unique to their business and provides seamless access to the customer without interruption. This also provides an additional space for the establishment to advertise for themselves and offer special deals that can be easily adjusted to unique events, as well as provide an ordering system for the user. Any business using the QR code or text number can have a geofence set up that once a user walks into the geofence area, a notification is pushed to the user system 14 through an application letting the user know that purchasing/betting is available and Wi-Fi details, text codes, or QR codes can be displayed (or directed to take a picture of at a certain location in the business) for the user to connect with.

For example, an NFL game is showing the code 7245 on the lower corner of the television. However, the location the customer is watching in has the further distinction of 89001. The user then texts the expanded number and they are sent to a version of user interface 32 where items unique to this location are available for ordering and purchase. No search is required for the user. In a bar with multiple televisions each playing different games or media, while each game can show its own text code/QR code, the store specific portion of the code is the same.

Using the text code to access the user interface 32 also allows the user to access any other functions described herein (such as messaging, sharing purchases, gifting, etc.) If the user is at a live event and also accessing a broadcast with a delay, any purchase/bet can also be required to proceed with a delay so that a user is not betting on something that has not yet been shown on the broadcast.

The user interface 32 can further include a search mechanism that allows individual users to search for media or particular scenes in media as well as products. Media can be searched by users by keywords (such as any identifying information in a particular scene or moment, landmarks, actor name, director name, type of media such as commercial, sports event, movie, or tv program, genre of media (drama, comedy, news, documentary, etc.), or combinations thereof located in the file name, file description, or meta data. If a media file itself has identifying information within scenes, that can be searched. Clips or portions of media can be saved by users (such as individuals, actors, or directors) in their account and can be searchable. For example, a user can search for “Scene in Forest Gump, when Forest runs through water at the National Mall in DC.” Any clips/portions returned by the search results can then be selected and shared with other users or edited further (to select a particular scene or moment) and then shared. Actors can also narrate scenes and explain to viewers what was going on in their mind during that scene and provide the scenes as clips for users to share. Media can be searched to find items for users to make purchases (such as clothing, shoes, jewelry, electronics, or home items) that appear in media. For example, a user can search for Ann Hathaway because they like the dress she had on in the movie “The Intern” at a certain scene. The search results can provide a link to purchase or a link to purchase within the store section as above. The search mechanism allows users to find content without having to leave the platform of the user system 14.

The user interface 32 can include a video recording mechanism, wherein users can record a video of themselves and share the video with other users through the user system 14. For example, users can record themselves reenacting scenes from movies, shows, commercials, video games, etc. The video recording mechanism can use sounds from any media (background music or other sounds) to bring reenactments to life. Users can also speak along with their favorite scenes or actors for performing complete in sync voice overs. Users can also create challenges with other users to create reenactments, which promotes social use of the media sharing and communication system 10. Users can also just create a video of themselves and speak about the media that they have viewed and/or shared with other users.

The user interface 32 can include a live interaction mechanism that allows a user to interact with a live media program and connect with an individual or individuals on the media, such as athletes, actors, analysts, or other media personalities. An icon on the user interface 32 can allow a user to make an interaction such as calling on a phone, sending a text, or making a video call (such as with FACETIME®, SKYPE®, WHATSAPP®) to the media program and interact with the individuals on the media program.

The user interface 32 can include an online betting module that allows users to bet on sports events (such as NBA, NFL, NHL, MLB, NASCAR), online games that users play against each other, or any other event taking place (elections, stocks, news, etc.). The online betting module can include an age verification mechanism according to requirements of cities, states, and/or countries. Bets can be placed before or during an event. The online betting module can be easily accessible through a button or icon on the user interface 32, or through the text code or QR code, or NFC technology described above, as well as voice commands. Any betting statistics related to the media can be shown on the user interface 32 either superimposed on the media or a separate bar at the side, bottom, or top of the media.

With the online betting module, when a user is making a bet in real-time, an algorithm in the user system 14 freezes action within the event to the user so that the action and odds do not move or change to protect the user from betting as odds go down and protecting a host betting company from the user seeing results of the bet (sinking putt, handoff instead of pass, etc.) before placing the bet. In other words, it is critical to ensure fairness for both users and a betting company while maintaining the integrity of the betting process. This can apply to any action of the user wherein the action is based on an event about to happen or any changing target. The target could be odds or stock price (such as watching MSNBC or FOX Business and buying and selling stock). The user needs to act in a frozen time frame.

In order to accomplish this, an algorithm constantly monitors the changing odds or target variables (such as value token) in real-time. When a user decides to place a bet, the algorithm temporarily freezes the action for that user. This means that the odds or target variables are locked in at the moment the user initiates the bet, preventing them from changing during the betting process. Freezing the action protects users from experiencing unfavorable changes in odds before they place their bets. It ensures that users receive fair and consistent terms at the time of betting, regardless of any fluctuations that may occur afterward. On the other hand, freezing the action also safeguards the betting company from users exploiting last-minute changes in odds to their advantage. By locking in the odds at the time of betting, the company can manage its risk exposure more effectively and maintain the integrity of its operations. The algorithm continues to monitor the ongoing events or market conditions even after the bet is placed. If any significant changes occur before the event concludes (such as a drastic shift in odds), appropriate measures can be taken to ensure fairness and integrity, such as offering refunds or adjusting payouts.

The user can use voice commands to place a bet with the online betting module in real-time. The voice command can initiate the algorithm to freeze the action while making the bet. For example, betting by voice command before a putt does not last so long that the putt is made or missed during the voice command bet. Therefore, the algorithm is designed to operate in real-time, syncing with a streaming service/media provider to provide users with a seamless experience of watching and betting simultaneously. This means that the algorithm processes voice commands quickly and efficiently, without causing delays that could impact the user's ability to place timely bets. The algorithm incorporates control mechanisms to manage the timing of bets. For example, it freezes action only during the brief moment when the user is placing a bet via voice command, ensuring that the user's betting experience aligns with the live action on the screen. Security features are integrated into the algorithm to guarantee the accuracy and validity of bets. This can include verification steps to ensure that bets are properly executed and recorded, as well as encryption protocols to safeguard user information and financial transactions. To prevent actions from overtaking bets, the algorithm executes voice-command bets with near-instantaneous speed. This ensures that bets are placed in a timely manner, even during fast-paced events like sports games. The algorithm continuously monitors the betting process to detect any anomalies or discrepancies, providing assurance to both users and the betting platform that bets are processed accurately and securely. Bets can also be synched with recording cameras for microbetting.

Therefore, the present invention also provides for a system for betting on media, including a user system having a user interface displaying media, the user system including the betting module having an algorithm stored on non-transitory computer readable media that allows a user to place a bet on an event in the media in real-time, the algorithm freezing action in the media temporarily for the user while the bet is placed, and the user system including a one-click purchase function for securely storing payment and address information of the user on non-transitory computer readable media allowing for secure and efficient placing of bets.

The present invention also provides for a method of betting on media, by a user placing a bet on an event in the media in real-time by activating an algorithm stored on non-transitory computer readable media on a user system, freezing action in the media temporarily for the user while the bet is placed with the algorithm, and the user placing the bet seamlessly using stored payment and address information securely stored on non-transitory computer-readable media within the user system. The method can include any of the steps described above.

The user interface 32 can further include an online food ordering module that allows users to order food advertised in commercials or online ads (such as a pizza store, a fast food company, a convenience store), as well as the type of food shown in a media program such as a tv show or movie. For example, a tv show may feature the cast eating at a high end restaurant, and different high end restaurants can be displayed on the user interface as offering online ordering and optionally delivery to the user. A cooking show can feature a particular type of cuisine (such as Chinese, Mexican, Japanese, Indian, Italian, Vietnamese, French, Fusion, Southern, Middle Eastern, Korean, Spanish, Eastern European, etc.), and the user interface can display restaurants of that type of cuisine that offer online ordering and delivery. A user can click on the restaurant and order food for either pick up or delivery. The user interface 32 can interact with existing food ordering/delivery platforms such as Seamless, Grubhub, Uber Eats, Postmates, Yelp, Caviar, DoorDash, and others. The online food ordering module can also be easily accessible through a button or icon on the user interface 32 or by a text code or QR code or NFC technology as described above. Any menus for a restaurant can be accessible on the user interface 32 with separate folders or sections for different parts of the menu (i.e. appetizers, main dishes, beverages, etc.) that are clickable by the user to view additional information. A user can also gift food and delivery to another user, and addresses of other users (contacts) can be stored in the user system 14 to easily send these items to another user. As with the store section, the online food ordering module can use a software program to identify and tag food items for purchase. Any food item within the media can be recognized with the software program and identified as an item available for purchase and that item can be located at a restaurant or delivery platform for purchase. The software program can analyze images within the media for pixel values and gradients to compare to images of food items available for sale in order to correctly identify the food items.

The user system 14 can also be in electronic communication with a camera (such as on a smartphone) so that a user can take a picture or view a separate screen or a store window with the camera and the user system 14 can identify items on the screen/in the store window/in the picture to purchase or place a bet on a sporting event. For example, a user can be watching a game at a bar, and they see an item they want to purchase, food they want to purchase, or decide they want to place a bet. They can open the camera on their smartphone and options for purchase syncs with the user system 14 and the user is prompted to continue with the purchase or bet. In another example, a user can pass by a store window, they aim the camera at the window or take a picture of the window, the user system 14 icons pop up, the items are identified as well as their source (from a store such as Saks Fifth Avenue, J. Crew, The Gap, etc.), and the user can make a purchase.

In one exemplary embodiment the user system 14 includes suitable software and user interface 32 for generating a user profile and attract other users or followers from social networks such as FACEBOOK®, TWITTER®, or otherwise, based upon the type of programming the user views. The user profile includes information of an individual user of the user system 14 to provide an indication of personal preference. For example, information that can be inputted into the user interface includes types of media, e.g., audio, video or identification information that a user enjoys. Other user preferences includes programming likes and dislikes including sports, movies, programming, celebrities, commercials, games, or otherwise. Other user preferences are possible. Users can also like or love any media, and this can be visible on their user profile and/or visible to other users or friends.

In greater detail, in one exemplary embodiment, the user profile provides the ability to indicate or like special interests or subscribe to their favorite athletes, actors, brands, or teams. In one particular configuration, the user profile is used to generate suggested viewing. The user profile provides the ability of a user to indicate particular interests which may include a particular actor, athlete, team, programming type (including shows and channels) or otherwise. Based upon the user profile, the media sharing and communication system 10 generates a listing of program based upon the user programming, which may include similar interest such as indicated actors, athletes, programming type or otherwise. Traditional methods require the user to search for something and then they begin to see advertisements directed towards their search. The present invention reverses this process. Artificial intelligence (AI) and tagging can be used to notify a user that a favorite person, brand, or team is going to be on a show/sports match/interview/other media program. Notifications can be provided in advance and/or at the time of the media broadcast. AI can use the likes or subscriptions to track viewers and tailor their viewing experience while using the system.

For example, should the user profile indicate a favorite baseball player and the particular baseball player is participating in an interview on one programming channel, such as a finance channel, the system 10 would indicate to the user that a player indicated in their user profile is on a particular channel providing the ability of the user to watch or record the particular programming. This concept can also be applied to actors, movie types, sports, other players, automobile manufactures or otherwise.

The user profile as visible in user interface 32 can further include tabs for trending news, sports, products, or clips of media. The user can add particular news sources, sports teams, or products they are interested in, and/or these can be generated based on information in the user profile. Users can also receive news updates based on their interests and preferences (such as finance, sports, local, etc.).

User profiles can also be tailored to a particular age group, such as for kids, with tailored advertising and suggested media suitable for a particular age group.

The communication system 10 provides socialization between users. The individual user of the user system 14 can send and receive a friend request, which must be approved by the recipient (i.e., second user system 14), in order to be added to the friend list and receive media. The communication system 10 is further configured to suggest friends or other users that have similar interest so that media can be sent to individuals, of a user profile friend list, that has similar interests. The communication system 10 further provides the ability to set up a notification that will notify a user when other users are online or offline. The individual user can also have an open profile option that allows anyone to follow them or send media, promoting community and meeting new people. A user can search for friends by name, username, gamer tag, telephone, address, or email that have been used in setting up a user profile.

In one particular exemplary embodiment, the user system 14 is integrated in hardware and/or software components of a cellular phone, i.e., smartphone, or tablet and is accessible to the user in the form of an application stored on non-transitory computer readable media or stored in a cloud. For example, the transmitter/receiver 22 comprises a transmitter/receiver 22 used in cellular phones for cellular communication. The display screen 24 comprises a screen and user interface of the cellular phone. Further, the cellular phone includes a digital recording device comprising a memory module for recording media, generating user interfaces, generating messages, combinations thereof or otherwise.

In one particular mode of operation, referring again to FIGS. 1-5, during viewing of media being disseminated from the media content provider 12, should the viewer find a particular media content of interest, the user records and initiates the user interface 32 to select other users to which to share the media content with. Optionally, the user includes a message with the recorded media, such as “check this out”, “did you see that play”, “best part of the movie”, or otherwise. The recorded media and message is sent to another user system 14, through the media content provider 12 and more specifically receiver 20. Should the recipient be authorized to receive the media and have sufficient memory, the message and media is transferred to the second user system 14. A user can also send a message to a second user about recommended programming that the second user may like.

Any commands within the user system 14 can be actuated (received and executed) through the voice of the individual users. For example, the individual user can use a voice command to rewind media, fast forward media, record media, add a message to the recorded media, and send the media and/or message to another user, as well as make purchases in the store section, use the online food ordering module (ordering or searching for food), use the betting module (placing and confirming bets), and gift items. Any of the commands can be actuated for a set amount of time determined by the user (such as by seconds (5 seconds, 10 seconds, 25 seconds) or minutes (1 minute, 5 minutes, 10 minutes)) at the time the voice command is given. For example, the individual user can command “Rewind by 10 seconds and record for 25 seconds. Send to Joe.” The individual user can command “purchase the red hat and send to Sheryl”.

In particular, when the message is a voice commentary, this allows the users (whether sending or receiving) to narrate clips or portions of media and to have open dialogue about particular clips of interest. This can allow the user the opportunity to act as a news anchor or sports commentator. Voice commentary allows the user to express with great detail what that media portion means to them along with why they decided to send it to a particular user. This can enhance the television viewing experience with friends and family when users are in two different households, and gives the user an opportunity to explain to the other user why they feel they should or should not like a show, actor, sports team, etc. With the voice commentary, the user can also talk over a desired portion of media, much like a sports commentator or news anchor, and narrate the portion of media.

The present invention creates excitement for the user when a user turns on their user system 14 and is notified that they have messages in their INBOX from friends and family as in FIG. 5. The present invention helps reduce channel surfing, because when a user turns on their user system 14, they have suggested media to review from their INBOX, as well as suggestions for media to view based on their likes and interests from their user profile, such as an actress they like is on a talk show at a certain time, a particular category of media (action, architecture, sports, animals, drama), or their favorite sports team is playing on a particular channel. Also, the user system 14 can allow for individual users to see what their friends are watching, and they can be notified either in their INBOX or on their display screen 24. This can promote group watching where the individual user can start watching a program along with their friend or group of friends.

Users can further send messages to other users without a media file attached with it. For example, a user can send another user a reminder that a program they like was on earlier, or simply send messages not related to media files such as greetings to another user. Users can also message each other while watching a live program, and this provides users the ability to watch a program together while being in different locations. Messages can pop up on their display screen 24 of their user system 14 or go directly to their INBOX while watching a live program.

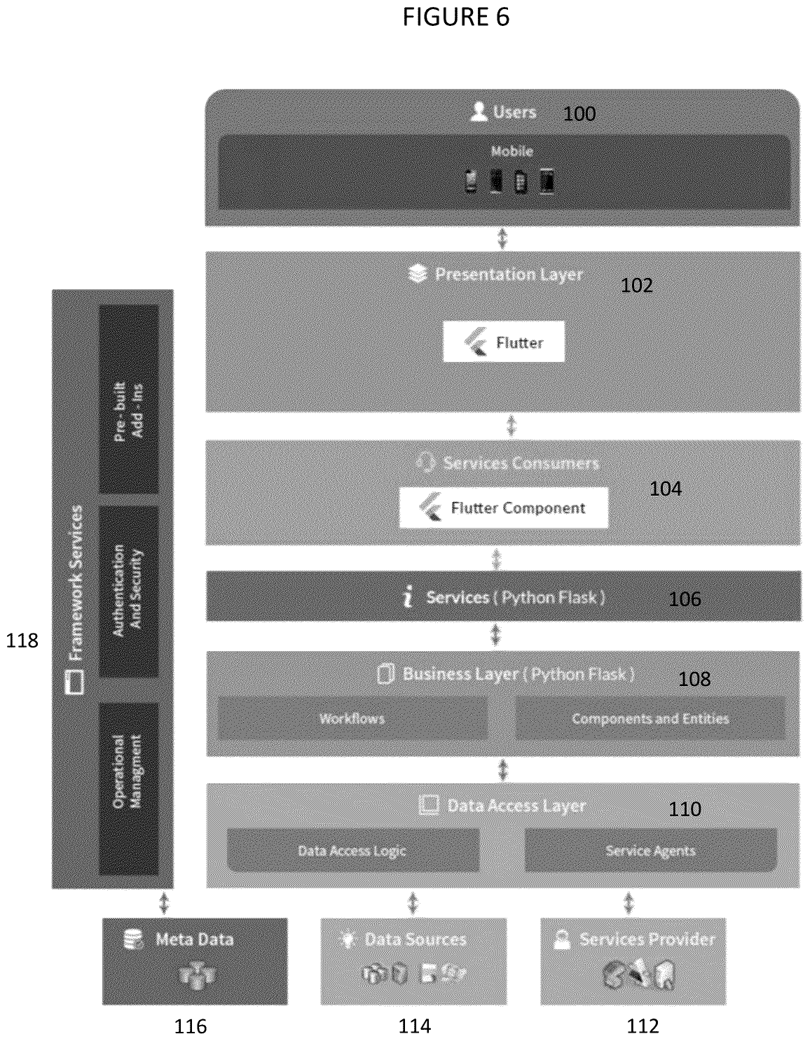

The user system 14 includes architecture as generally shown in FIG. 6. Users at 100 use their smartphone, tablet, other mobile devices, etc. including the user system 14 integrated therein (such as with the application) and access a presentation layer 102. The presentation layer 102 is responsible for data handling and graphic management which ensures that the communications that pass through it are in the appropriate form for the recipient application. Flutter is one example of a scripting language that can be used, it is an open-source user interface software development kit created by Google. The presentation layer 102 is in electronic communication with services consumers 104. The services consumers 104 is in electronic communication with services (Python flask) 106. The services (Python flask) 106 is in electronic communication with a business layer 108, which includes workflows and components and entities. In the business layer 108, Node can be used for a backend and for REST API's which works as a handshaking mechanism between the business layer 108 and the presentation layer 102. The business layer 108 is in electronic communication with a data access layer 110, which includes data access logic and service agents. The data access layer 110 is in electronic communication with services provider 112 and data sources 114. Meta data 116 is in electronic communication with framework services 118. The framework services 118 can include operational management, authentication and security, and pre-built add-ins.

The user system 14 can use and integrate AI at many different levels, such as for recommendation of content, creating an image-based engine, training models, advertising, creating personalized messages, recommendation of purchases, polling users, tracking statistics, tracking social media, and customizing viewing experiences.

A recommendation engine in the user system 14 uses various algorithms to deliver personalized content suggestions to the user. Such algorithms can include, but are not limited to:

### 1. Collaborative Filtering:

User-Based Collaborative Filtering: This algorithm recommends items based on the preferences of users with similar tastes. If User A and User B have similar preferences, items liked by User A but not yet seen by User B are recommended to User B.

Item-Based Collaborative Filtering: This approach recommends items that are similar to ones the user has liked in the past. For example, if a user likes Item X, they may be recommended Item Y, which is often liked by other users who liked Item X.

### 2. Content-Based Filtering:

Attribute Matching: This algorithm recommends items based on the features of items the user has previously interacted with. For example, if a user likes action movies, they are recommended other action movies based on attributes like genre, director, or actors.

### 3. Matrix Factorization:

Singular Value Decomposition (SVD): This technique decomposes the user-item interaction matrix into lower-dimensional matrices, capturing latent factors that influence preferences. It is used to predict missing values and make recommendations.

Alternating Least Squares (ALS): An optimization technique often used in conjunction with matrix factorization to minimize the error in predictions. ALS alternates between fixing user factors and item factors to optimize the recommendation matrix.

### 4. Hybrid Models:

Combining Collaborative and Content-Based Filtering: Hybrid models combine multiple recommendation techniques to improve accuracy and coverage. For example, a system might use both collaborative filtering and content-based filtering to provide more comprehensive recommendations.

### 5. Nearest Neighbors:

K-Nearest Neighbors (KNN): This algorithm identifies the most similar items or users based on distance metrics (e.g., Euclidean distance) and recommends items based on the preferences of these nearest neighbors.

### 6. Deep Learning:

Neural Collaborative Filtering (NCF): Deep learning models, such as neural networks, can capture complex patterns in user-item interactions. NCF combines neural networks with collaborative filtering techniques to provide personalized recommendations.

Autoencoders: These are used to learn compact representations of users and items, capturing non-linear relationships and improving recommendation accuracy.

### 7. Factorization Machines:

Factorization Machines (FM): This algorithm generalizes matrix factorization and can model interactions between variables in high-dimensional sparse datasets. It is useful for capturing complex patterns in user-item interactions.

### 8. Reinforcement Learning:

Contextual Bandits: This approach models the recommendation problem as a multi-armed bandit problem, where the algorithm learns to balance exploration (trying new items) and exploitation (recommending known items) based on user interactions.

### 9. Association Rule Learning:

Apriori Algorithm: This algorithm finds frequent item sets and generates association rules, identifying items that are commonly purchased together and using this information to make recommendations.

### 10. Graph-Based Algorithms:

Graph Convolutional Networks (GCNs): GCNs leverage the relationships between users and items represented as a graph to make recommendations. These algorithms capture the structure of user-item interactions and can provide insights based on graph-based features.

With an image search engine in the user system 14, several key algorithms and techniques enable efficient and accurate retrieval of images based on user queries. The primary algorithms and methods used can include, but are not limited to:

### 1. Feature Extraction

Convolutional Neural Networks (CNNs): CNNs are commonly used for feature extraction from images. They learn hierarchical features from images (e.g., edges, textures, patterns) through multiple layers of convolutions. Pre-trained models like VGG16, ResNet, and Inception can be used to extract feature vectors from images.

Deep Embeddings: CNNs can convert images into deep feature embeddings, which are high-dimensional vectors representing the content of the image. These embeddings capture essential characteristics and are used for comparison and retrieval.

### 2. Image Indexing

Vector Indexing: Once feature vectors are extracted, they are indexed using efficient data structures such as KD-Trees, Ball Trees, or more advanced methods like Approximate Nearest Neighbor (ANN) algorithms. This allows for fast retrieval of similar images based on their feature vectors.

Hashing: Locality-Sensitive Hashing (LSH) and other hashing techniques can be used to create compact representations of image features, enabling quick approximate retrieval of similar images.

### 3. Similarity Measurement

Euclidean Distance: Measures the distance between feature vectors in a high-dimensional space. It is commonly used to find the closest matching images.

Cosine Similarity: Calculates the cosine of the angle between two feature vectors, which helps in measuring similarity in terms of orientation rather than magnitude. It is useful for comparing image embeddings.

Manhattan Distance: Computes the distance between feature vectors by summing the absolute differences. It is another metric used for similarity measurement.

### 4. Image Retrieval

Nearest Neighbor Search: Searches for the nearest neighbors to the query image based on the distance metrics (e.g., Euclidean or cosine distance) calculated in the feature space. Algorithms like K-Nearest Neighbors (KNN) or approximate nearest neighbor methods are used for this purpose.

Ranking Algorithms: Once similar images are identified, they are ranked based on relevance to the query. Techniques like learning-to-rank models can be employed to optimize the ranking of search results.

### 5. Content-Based Image Retrieval (CBIR)

Color Histograms: Analyzes color distributions in images to find similar images based on color patterns.

Texture Analysis: Examines texture patterns and spatial relationships in images to identify similar textures.

Shape Matching: Uses algorithms to compare and match shapes or contours within images, useful for finding images with similar shapes.

### 6. Semantic Understanding

Object Detection: Algorithms like YOLO (You Only Look Once) or Faster R-CNN detect and classify objects within images, enabling semantic understanding and improving search accuracy.

Image Captioning: Uses models like Show and Tell or Transformer-based architectures to generate textual descriptions of images, which can be used to enhance search queries with semantic understanding.

### 7. Data Augmentation

Image Transformation: Techniques such as rotation, scaling, cropping, and color adjustment are used to augment the dataset, improving the robustness and accuracy of the image search engine.

### 8. Machine Learning Models

Transfer Learning: Utilizes pre-trained models on large datasets to adapt to specific image search tasks. This approach leverages existing knowledge to improve feature extraction and retrieval performance.

Deep Learning Models: Advanced models, including Generative Adversarial Networks (GANs) and attention mechanisms, can be employed to enhance image representation and search capabilities.

Specifically with respect to advertising, the user system 14 through AI collects and delivers personalized information to advertisers to assist with and provide personalized ads to the user as well as analyze data from user clicks on ads. This removes the blanket style currently used. Currently, companies such as Nielsen collect data related to advertising through television broadcasts but not with streaming services and so they miss a large number of users viewing advertisements on streaming services.

With data collection and analysis, AI can efficiently gather and analyze vast amounts of data from various sources such as browsing history, social media activity, and past purchase behavior. By understanding user preferences, AI can identify patterns and trends that indicate what type of ads can be most relevant to each individual user. AI can also identify which ads are effective at making users click on them for more information and which ads lead to a user purchasing an item or service. AI can identify which streaming service or media generates more clicks on ads when they are shown on multiple streaming services or medias. Many companies use multiple versions of ads shown to different types of users, different media, or at different times of day. AI can determine which ad is most effective for a particular user, particular media, or particular time of day based on the number of clicks and eventual purchases. Any analytics performed on the collected data by the user system 14 and AI can be sent to a third party, such as an advertising firm, and advertising analysis company, or company that is running the ads.

With segmentation and targeting with AI, advertisers can segment audiences more precisely based on behavior, demographics, and psychographics. This level of granularity ensures that ads are only shown to those who are most likely to be interested, reducing wasted ad spend.

With dynamic content creation, AI can help in generating personalized ad content that resonates with specific audience segments. For instance, AI-driven tools can customize ad visuals and copy based on the user's preferences, location, or even the time of day.

With predictive analytics, AI can predict future consumer behavior based on past data, allowing advertisers to target users at the right time with the right message. This predictive capability increases the chances of conversion by reaching customers when they are most likely to engage.

With real-time adjustments, AI allows for real-time ad optimization. By continuously monitoring ad performance, AI can make instant adjustments, such as tweaking the targeting criteria or modifying the ad creative, to ensure the best possible results.

The AI can revolutionize the way customers and advertisers connect by leveraging its learning capabilities to create more effective and meaningful interactions and connect users/viewers to advertisers.

With in-depth customer insights, AI can analyze vast amounts of customer data, including browsing history, purchase behavior, and social media interactions. By understanding individual preferences, interests, and buying habits, AI can build detailed customer profiles that help advertisers target their messages more effectively.

With advertiser understanding, AI can learn about advertisers' goals, target demographics, and campaign performance. By analyzing historical data and current trends, AI can identify the best strategies for reaching specific customer segments and achieving campaign objectives.

With matching customers with advertisers, using the insights gathered, AI can match customers with advertisers whose products or services align with their preferences. This ensures that customers are presented with relevant advertisements that are more likely to resonate with their interests and needs.

With any ads shown on the user system 14, the user can click on an icon on the screen or on the ad and information about products in the ad shown or about the company showing the ad can be sent to their email listed in their user profile.

Therefore, the present invention provides generally for a method of collecting and analyzing advertising data, by a user interacting with an advertisement on media (and preferably streaming media) within the user system 14, the user system 14 collecting data relating to the user's interaction with the advertisement and storing the data on non-transitory computer readable media, AI on the user system analyzing the collected data, and the user system 14 providing the analyzed data to a third party. Any of the steps as described above can be performed with this method.

Specifically with respect to content recommendations to users, AI can significantly enhance how viewers are shown content, going beyond standard recommendation algorithms to deliver experiences truly tailored to individual preferences. AI can be leveraged to achieve this in the following ways.

With deep learning for preference understanding, AI can analyze user behavior at a granular level, including viewing habits, interaction history, and even subtle indicators like viewing duration and content replays. Through deep learning models, AI can gain a nuanced understanding of what each user truly enjoys, rather than relying solely on broad categories or past interactions.

With personalized content discovery, instead of generic recommendations, AI can curate a unique content lineup for each user based on their specific interests. This could include not just popular content but also niche selections that align with their tastes, offering a more enriching and satisfying viewing experience.

With contextual awareness, AI can factor in contextual elements like time of day, mood (based on previous viewing choices), or even the current social setting (alone or with friends) to suggest content that is most relevant in that moment. This level of personalization ensures that the content shown is not just aligned with preferences but also with the user's current context.

With predictive personalization, by using predictive analytics, AI can anticipate what a user might want to watch next, even before they realize it. This proactive approach ensures that the content lineup evolves with the user's changing preferences, keeping the experience fresh and engaging.

With interactive and adaptive algorithms, AI-powered systems can learn and adapt in real time, adjusting recommendations as users engage with content. For instance, if a user unexpectedly enjoys a type of content they have not watched before, the AI can quickly pivot and incorporate similar content into future recommendations.

AI can also be used to help users create personalized messages for friends that recommend content or products to their friends. AI can enhance this process as follows.

With analyzing friendship dynamics, AI can analyze the relationship between users and their friends by examining past interactions, shared interests, and communication styles. This allows AI to tailor the tone and content of recommendations to match the specific dynamics of each friendship, making the message more engaging and relevant.

With content and product matching, AI can identify content or products that are most likely to resonate with a user's friends based on their individual preferences, past behavior, and social media activity. By understanding what each friend is interested in, AI can suggest highly relevant recommendations that are more likely to be appreciated and acted upon.

With natural language generation, AI can generate personalized messages using natural language processing (NLP) that reflect the user's unique voice and the context of their relationship with each friend. Whether it is a casual suggestion, a funny comment, or a heartfelt recommendation, AI can craft messages that feel authentic and personal.

With contextual awareness, AI can take into account the timing and context of the recommendation. For example, if a friend recently mentioned a particular interest or upcoming event, AI can incorporate that context into the message, making the recommendation more timely and meaningful.

With customization options, AI can offer customization options, allowing users to tweak the generated message before sending it. This ensures that while the AI does the heavy lifting, the final message still has a personal touch from the user.

With learning and adapting, AI can learn from the responses to previous recommendations, adapting future suggestions to be even more aligned with what the user's friends appreciate. Over time, this makes the AI's suggestions increasingly effective and personalized.

With cross-platform integration, AI can integrate with various communication platforms, making it easy to send personalized recommendations through text, email, social media, or messaging apps. This seamless integration ensures that users can share content or products with their friends wherever they communicate.

AI can be used to significantly enhance the shopping experience for users by integrating user interests with geo-tagging data to recommend relevant items in specific locations where products and services are offered for purchase. AI can facilitate this in the following ways.

With interest-based recommendations, AI algorithms analyze user interests based on their browsing history, past purchases, and engagement with content. By understanding these interests, AI can suggest items that align with what users are likely to want or need.

With geo-tagging integration, AI can identify when and where users are located based on geo-tagging data. This information is used to suggest items or services that are available for purchase in nearby stores or local areas. For example, if a user is near a bookstore, AI can recommend new book releases or special promotions at that location.

With contextual offers and discounts, AI can provide users with contextual offers and discounts based on their current location. If a user is near a restaurant, AI can suggest special meal deals or promotions available at that establishment, enhancing the relevance of the recommendations.

With local inventory awareness, AI can access real-time inventory data from local stores or online retailers that have geo-tagging capabilities. This allows users to receive recommendations for items that are currently in stock and available for immediate purchase or pickup.

With personalized shopping alerts, AI can send personalized shopping alerts or notifications to users when they are in proximity to stores or services that offer products or deals aligned with their interests. For instance, a user interested in outdoor gear can receive a notification about a sale on hiking equipment when they are near an outdoor sports store.

AI can significantly improve user engagement by enabling direct polling and feedback mechanisms from shows and advertisements. This approach allows users to share their thoughts, views, and opinions in real time, providing valuable insights to platform owners and broadcasters. AI can facilitate this in the following ways.

With real-time polling, AI can integrate with streaming platforms to enable real-time polling during shows and advertisements. Users can participate in polls or provide feedback directly through their devices, allowing them to express their opinions on content, ads, and overall viewing experience instantly.

With instant feedback collection, AI can collect and analyze feedback as it is submitted, providing broadcasters and platform owners with immediate insights into user sentiment. This real-time feedback helps in assessing the effectiveness of content and advertisements, allowing for quick adjustments if necessary.

With customized polling experiences, AI can personalize polling experiences based on user profiles and viewing history. For example, AI can tailor poll questions to align with the user's interests or past interactions, ensuring that the feedback collected is relevant and actionable.

With sentiment analysis, AI-powered sentiment analysis can evaluate the tone and emotion behind user feedback. By understanding whether responses are positive, negative, or neutral, broadcasters can gauge audience reactions more accurately and make informed decisions about content and ad strategies.

With engagement metrics, AI can track and analyze engagement metrics related to polling activities, such as participation rates and response times. These metrics provide insights into how engaged users are with the content and ads, helping broadcasters optimize their approach.

With direct communication channels, AI can facilitate direct communication between viewers and broadcasters. For instance, AI-driven chatbots or messaging systems can allow viewers to ask questions, share suggestions, or report issues in a seamless manner, fostering a more interactive and responsive viewing experience.

AI can be used to track stats in sports broken down by leagues, teams, players, etc. for the purpose of the user having useful knowledge to make informed decisions and for the use of betting through the system with the betting module. AI can revolutionize the way sports statistics are tracked and utilized, offering detailed insights and data that enhance decision-making and betting strategies. AI can be applied to track and analyze sports statistics across various dimensions in the following ways.

With comprehensive data collection, AI can aggregate and analyze extensive datasets from multiple sources, including league records, team performances, player statistics, and historical data. This comprehensive approach ensures that all relevant metrics are considered, providing a holistic view of the sports landscape.

With detailed breakdown, AI can break down statistics by league, team, and player, offering granular insights. For example, AI can track team performance metrics such as win-loss records, scoring averages, and defensive stats, as well as individual player metrics like goals, assists, and injury history.

With advanced analytics, AI algorithms can perform advanced statistical analyses, such as trend analysis, predictive modeling, and machine learning. These analyses can identify patterns, forecast future performance, and uncover hidden insights that are not immediately apparent from raw data alone.

With real-time updates, AI can provide real-time updates and dynamic tracking of sports statistics during live games. This real-time capability ensures that users have the most current information available for making informed decisions and adjusting betting strategies on the fly.

With predictive insights, using historical data and current performance metrics, AI can generate predictive insights into future outcomes. For example, AI models can forecast game results, player performance, and potential upsets, aiding in strategic betting decisions.

With personalized recommendations, AI can offer personalized betting recommendations based on user preferences, historical betting behavior, and current statistics. This personalization helps users make more informed bets aligned with their individual strategies and interests.

With risk management, AI can assess and manage risk by analyzing betting patterns, detecting anomalies, and providing risk assessment tools. This helps users make more calculated bets and avoid potential pitfalls.

With visualizations and dashboards, AI can create interactive visualizations and dashboards to present sports statistics in an easily understandable format. These visual tools help users quickly interpret complex data and make informed decisions.

With historical comparisons, AI can facilitate comparisons of current performance metrics with historical data, allowing users to evaluate how current teams and players stack up against past performances and trends.

AI can significantly enrich the TV and streaming experience by tracking and integrating social media of leagues, teams, players, actors, and shows. This approach brings a social element to entertainment by keeping users up to date with their favorites and engaging them more deeply. AI can facilitate this in the following ways.

With real-time social media tracking, AI can monitor social media platforms for real-time updates related to leagues, teams, players, actors, and shows. By analyzing posts, tweets, and other content, AI ensures that users receive the latest news, highlights, and updates as they happen.

With customized content feeds, AI can curate personalized social media feeds based on users' interests and preferences. For example, if a user follows a specific team or actor, AI can deliver relevant social media content directly related to those interests, including news, fan interactions, and behind-the-scenes updates.

With engagement analytics: AI can analyze social media engagement metrics such as likes, shares, and comments to gauge the popularity and public sentiment surrounding teams, players, actors, and shows. This analysis helps users stay informed about trending topics and popular content.

With integrated social features, AI can integrate social media features into streaming platforms, allowing users to interact with content and fellow fans. Features such as live chat, polls, and social sharing can enhance the viewing experience and foster a sense of community.

With influencer and fan insights, AI can identify and track influencers and prominent fans related to specific teams, players, or shows. By providing insights into who is influencing the conversation and how fans are engaging, AI helps users connect with the broader fan community.

With event and announcement notifications, AI can alert users about important events, announcements, and updates from their favorite teams, actors, or shows. For instance, users can receive notifications about game schedules, actor interviews, or new episode releases.

AI can be used to transform viewing experiences for the user with AI-powered personalization. AI is revolutionizing how viewers experience content by moving beyond traditional programming schedules and providing a fully customized viewing experience. The user no longer needs to look for programming because AI finds content for the user based on their interests. AI can reshape the viewing experience in the following ways.

With personalized content delivery, AI algorithms analyze users' interests, viewing history, and preferences to curate a personalized content feed. Instead of searching for shows or movies, content is automatically recommended based on what the user likes, making the experience more intuitive and engaging.

With dynamic content suggestions, AI continuously learns from user behavior, adapting to changing preferences over time. Whether a user's interests evolves or they explore new genres, AI updates recommendations in real-time, ensuring that content suggestions remain relevant and fresh.

With contextual recommendations, AI can consider contextual factors such as time of day, mood, or even current location to tailor recommendations. For instance, AI can suggest a relaxing movie in the evening or an engaging documentary during the day based on these contextual cues.

With interactive content experiences, AI can enhance the interactivity of content by integrating features like real-time polls, interactive storytelling, or viewer-driven plot choices. This level of personalization turns passive viewing into an active and immersive experience.

With seamless integration across devices, AI ensures a consistent viewing experience across multiple devices, such as smartphones, tablets, and smart TVs. Users can start watching content on one device and seamlessly continue on another without losing their place.

With personalized notifications, AI can send notifications about new content releases or updates that align with the user's interests. For example, if a user follows a particular show or actor, AI can alert them when new episodes or related content become available.

With enhanced discoverability, AI can introduce users to new content they might not have discovered otherwise. By analyzing similar interests and connections, AI can recommend lesser-known but relevant shows or movies that match the user's taste.

With adaptive viewing preferences, AI can adjust content recommendations based on feedback and interaction. If a user skips or rates certain content, AI uses this feedback to refine future suggestions, ensuring a more tailored experience.

With automated content curation, AI automates the process of curating content based on detailed user profiles. This eliminates the need for manual searches and helps users find exactly what they want to watch with minimal effort.

AI can be used to enhance integration of the media sharing and communication system 10 and user system 14 with external service providers, such as cable television providers, streaming services, betting services, gaming services, online food ordering services, shopping services, etc. In the modern technological landscape, integrating with various external service providers is essential for enhancing functionality and providing seamless user experiences. However, these integrations can be complex, time-consuming, and fraught with challenges related to compatibility, data consistency, and maintenance. AI can be used to streamline and optimize the process of integrating the user system 14 with external service providers by both finding the fastest/easiest means of integration as well as storing this process to use going forward, thereby improving efficiency, reducing errors, and enhancing overall integration quality. In other words, after a first integration with an external service provider that may or may not require manual assistance, the AI learns how to perform subsequent integrations based on specifications from various vendors. Therefore, the user system 14 can include an integration module operated by AI for streamlining integration with external service providers.

AI can be used to automate integration processes by automating the mapping, transformation, and synchronization of data between the user system 14 and external service providers, improve compatibility by enhancing the ability to handle diverse data formats, protocols, and APIs through intelligent AI-driven adaptation, increase efficiency by reducing the manual effort and time required for integration tasks by leveraging AI tools, and enhance error detection by implementing AI-based mechanisms to detect and resolve integration issues proactively.

First, in data collection and analysis, integration requirements are gathered. The AI collects detailed requirements and specifications for integrating with various external service providers. Providers generally publish their full API spec in a format called swagger that the AI can ingest. The AI also analyzes past integration projects to identify common challenges, data formats, and patterns.

Next, AI model development is performed. Machine learning models are developed to automate the mapping and transformation of data fields between systems. Different fields can be called different things between the various providers, so it is critical that the AI maps fields to ensure consistency between experiences. Algorithms are created that are capable of interpreting and adapting to different API standards and protocols. AI-based systems are implemented to identify and resolve integration errors in real-time.

Next, tool development and integration are performed. An integration platform is built or enhanced with AI capabilities for data mapping, API adaptation, and error handling. Plugins or extensions are developed for popular development environments that integrate with AI tools for integration tasks. At this point integration of the external service provider with the user system 14 is essentially complete.

Next, testing and validation can be performed on the complete integration. AI-driven testing frameworks are deployed to validate the functionality and reliability of integrations. AI-based monitoring solutions are implemented to ensure ongoing integration performance and detect issues early.

Finally, feedback and iteration are performed. Feedback is gathered from integration teams and stakeholders (i.e., any users or developers) to refine AI models and tools. AI models are regularly updated and improved based on new data, emerging technologies, and feedback. At this point, feedback and integration are complete.

There are several benefits to this AI integration method. Streamlined integration is achieved because automation of data mapping and transformation reduces manual effort and speeds up integration processes. Enhanced compatibility is provided because AI tools ensure better handling of diverse data formats and API protocols, improving integration quality. Increased efficiency is provided because reduced manual workload and faster resolution of integration issues lead to greater overall efficiency. Proactive issue resolution is provided because early detection and automated resolution of integration issues minimize disruptions and downtime. Overall, by leveraging AI to enhance integration processes with external service providers, the present invention provides technical effects of significant improvements in efficiency, compatibility, and overall quality in integrating external systems. This approach streamlines integration tasks, reduces manual effort, and ensures robust and reliable connections with external systems.

The present invention provides generally for a method of integrating the user system 14 (i.e., the media and shopping interface) with an external service provider, by AI integrated in the user system 14 gathering integration requirements for the external service provider, performing AI model development, performing tool development and integration of the user system 14 with the external service provider, performing testing and validation, and performing feedback and iteration.

AI can further be used with other actions within the user system 14, such as skipping ads in media, making purchases, ordering food, placing bets, finding out stat lines related to bets, etc.

The user system 14 can also incorporate eye-tracking technology to make it easier for users to interact with the user system 14 through user devices such as smartphones and tablets. This enables users to purchase items, gift items, save content for later, share content, make and place bets, lock and unlock the user's account, and any other action that the user system 14 provides through the use of their eyes.

The user system 14 includes an eye-tracking mechanism that uses sensors and cameras integrated into smartphones and tablets to monitor and analyze where a user's gaze is focused on the screen. By detecting eye movements and the point of focus, the technology can determine which items or elements the user is interested in. When a user's eyes focus on a specific product or item, the user system 14 can trigger interactive features such as a pop-up with detailed information, a quick-buy button, or an option to add the item to a cart. This allows users to easily make purchases or save items for later with minimal effort.

Eye-tracking can facilitate gifting and sharing by allowing users to select items or content by simply looking at them. For instance, if a user gazes at a gift item, the user system 14 can prompt options to share the product with friends or send it as a gift directly from the device. Users can save items or content for future reference by focusing their gaze on a “save” or “bookmark” button. The technology can then add the selected items to a wish list or saved items list, making it easy for users to revisit their interests later.

For betting applications, eye-tracking can streamline the process by allowing users to place bets with their gaze. By looking at betting options or odds, users can select their choices and confirm their bets through eye-tracking prompts. This makes the betting experience more fluid and interactive.

Eye-tracking can provide personalized interactions based on user preferences and gaze patterns and integrate with AI in the user system 14. For example, the user system 14 can highlight relevant offers or recommendations based on the items a user spends the most time looking at.

Eye-tracking technology can enhance accessibility by offering an alternative input method for users who may have difficulty using touchscreens or traditional input devices. This inclusive approach ensures a seamless experience for all users.

The user system 14 can provide real-time feedback and confirmations as users interact with items. For example, if a user's gaze hovers over a product, the user system 14 can display a quick view or confirmation prompt, improving the efficiency of the interaction.

The present invention therefore provides for a media and shopping interface for purchasing items on media, including the user system 14 having a user interface 32 displaying items for purchase that is accessible through a user initiating a connection between a mobile device of a user system having a user interface and a media screen that pushes data of items for purchase or available bets to the mobile device, the user system 14 including software stored on non-transitory computer readable media that recognizes and tags purchasable items in the media and the user system including artificial intelligence (AI) integrated therein capable of performing each of the functions described above, wherein the user system 14 displays items for purchase, the user system 14 including a one-click purchase function allowing for secure and efficient purchases. The one-click purchase function can securely store payment and address information of the user on non-transitory computer readable media or can link with and use existing payment information as described above. The items displayed for purchase can also include food with the food ordering module described above, and the items for purchase can also be bets as described above. The media and shopping interface can include any of the AI functionality described above.

The present invention also provides for a method of shopping on media, including the steps of a user initiating a connection between a mobile device of a user system 14 having a user interface 32 and a media screen that pushes data of items for purchase or available bets to the mobile device, wherein the user interface 32 is remote from the media being shown, AI integrated in the system retrieving images based on user queries software recognizing and assigning functional tags to purchasable items in the media, the functional tags not being visually displayed on a screen during media playback, the user selecting an item in the media by clicking on it, the user accessing a one-click purchase function on the screen, and the user purchasing the item seamlessly such as with using stored payment and address information securely stored on non-transitory computer-readable media within the user system 14 or linking and using existing payment information of the user. The items displayed for purchase can also include food and the details of the food ordering module described above can be included in this system, and the items can also include bets as described above. The method can include any of the steps described above adding AI functionality to the user system 14.

The present invention also provides for a method of sharing portions of media and watching a live program, by a first individual user recording a portion of media and recording a message (such as video, text, voice, or combinations thereof), transmitting the portion of media and message to a second individual user if the second individual user is authorized to view the portion of media, the second individual user viewing the portion of media and message, the first individual user recording a message during a live program and transmitting the message to the second individual user, and the second individual user recording a message during the live program and transmitting the message to the first individual user. This method can be performed by using the media sharing and communications system 10 described above. More particularly, the recording step is further defined as the first individual user recording a portion of media with a recording mechanism 26 in a first user system 14, the transmitting step is further defined as transmitting the portion of media and message with a first user transmitter/receiver 22 to a second user transmitter/receiver 22, and the viewing step is further defined as a second individual user viewing the portion of media and message with a second user system 14. Any notifications described above can be sent to the first individual user or second individual user, such as notifying the first individual user if the second individual user is not authorized to view the portion of media. The users can create user profiles and the user systems 14 can generate suggested programming based on the user profile. The method can further include notifying the first (or second) individual user of messages in an inbox and suggestions of programming when the first (or second) user system 14 is turned on. The users can also shop in the store section of the user system 14 or list products for sale. The users can place an online bet with the online betting module. The users can order food with the online food ordering module. The first individual user can also record a video of themselves and share the video with the second individual user as described above. While watching the live programming, any users can also live stream a video of themselves to share with other users in the group watching the media on their user interfaces 32. The streaming videos can appear to the side of the media being watched or be minimized when desired.

The present invention also provides for method of sharing media by a first individual user searching for media of program information, programming shows, movies, concerts, sporting events, online games, or commercials by keywords and selecting a portion of media returned in search results, the first individual user recording a message of video, text, voice, emojis, images, or combinations thereof, transmitting the portion of media and message to a second individual user if the second individual user is authorized to view the portion of media, and the second individual user viewing the portion of media and message. The searching step is performed with the searching mechanism as described above. The first individual user can also record a video of themselves and share the video with the second individual user as described above.

The present invention also generally provides for a method of sharing portions of media, by a first individual user recording a portion of media and recording a message chosen from the group consisting of video, text, voice, and combinations thereof, transmitting the portion of media and message to a second individual user if the second individual user is authorized to view the portion of media, the second individual user viewing the portion of media and message, the first individual user recording a message and transmitting the message to the second individual user, and the second individual user recording a message and transmitting the message to the first individual user, wherein any of the steps are performed by a voice command. The first individual user can also record a video of themselves and share the video with the second individual user as described above.

The invention is further described in detail by reference to the following experimental examples. These examples are provided for the purpose of illustration only, and are not intended to be limiting unless otherwise specified. Thus, the invention should in no way be construed as being limited to the following examples, but rather, should be construed to encompass any and all variations which become evident as a result of the teaching provided herein.

### Example 1

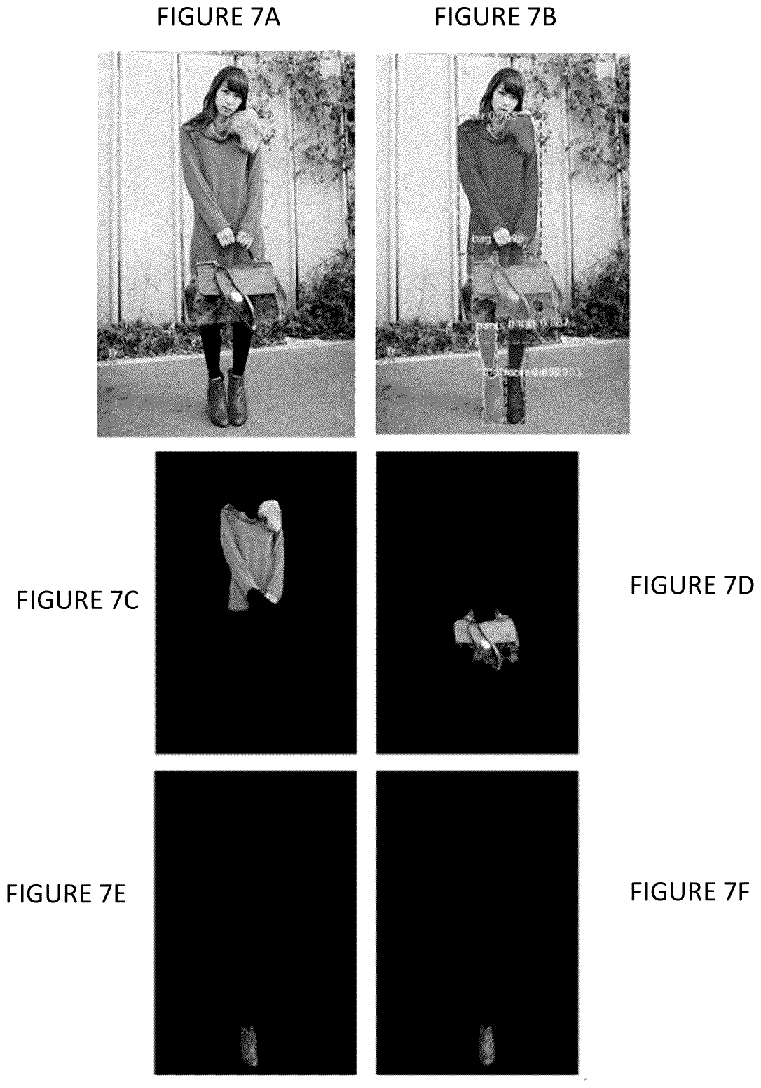

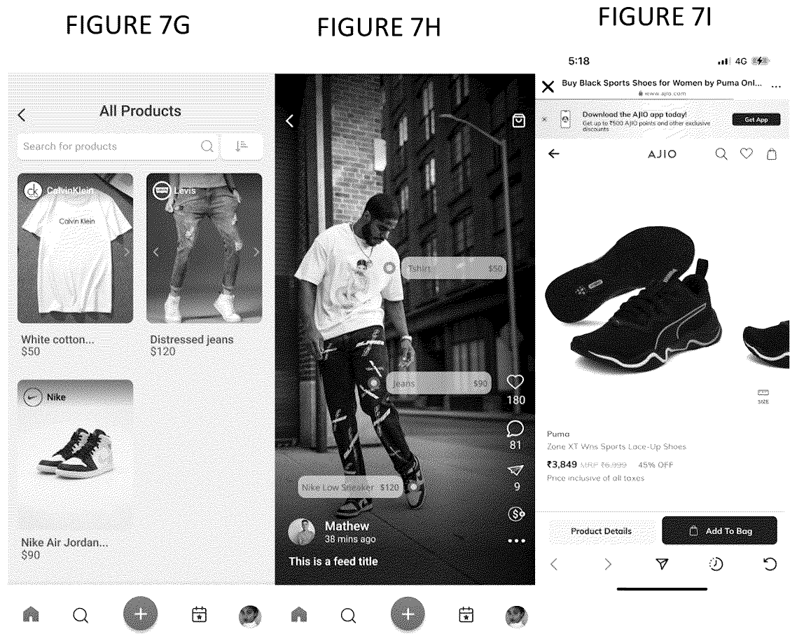

The following method was used to extract merchandise, clothing, etc. for product recognition from media content so that it can be searched in the open marketplace on any website. In one particular example, the product can be found in the Amazon marketplace to provide quick checkout and tracking. Example segmentation is shown in FIGS. 7A-71.

FIG. 7A shows an outfit found in media, FIG. 7B shows recognition of pieces of an outfit, FIG. 7C shows a coat, FIG. 7D shows a bag, FIG. 7E shows a shoe, and FIG. 7F shows a shoe. FIG. 7G shows products found and recognized in the media image of FIG. 7H, and FIG. 7I shows suggested products based on the image of FIG. 7H.

For example, the user system 14 allows the user to download the media (from any source such as, but not limited to, YOUTUBE®), frames of a time period of one second can be extracted using cv2 library (such that a 10 second video extracts 10 frames), and the extracted frames are passed to a Mask ROCNNN model to identify products/clothes in the frames and it identifies and marks the portion of the detected items. The detected items are cropped using cv2 crop tool and based on the dimensions the data is saved on the server. The cropped items are taken and sent to a web automation tool (such as selenium webdriver), which automatically uses the cropped images and searches with Amazon StyleSnap to find related results and/or searches with Google and selects the images that have the same product tag to redirect the user to the relatable source. If Chrome-driver is used as a browser and the match is found, it can be uploaded onto an S3 server and at the same time a database is updated. The user system 14 then deletes the folder created on the server because all the data is in the database itself.

Throughout this application, various publications, including United States patents, are referenced by author and year and patents by number. Full citations for the publications are listed below. The disclosures of these publications and patents in their entireties are hereby incorporated by reference into this application in order to more fully describe the state of the art to which this invention pertains.

The invention has been described in an illustrative manner, and it is to be understood that the terminology which has been used is intended to be in the nature of words of description rather than of limitation.

Obviously, many modifications and variations of the present invention are possible in light of the above teachings. It is, therefore, to be understood that within the scope of the appended claims, the invention can be practiced otherwise than as specifically described.

What is claimed is:

1. A media and shopping interface for purchasing items on media, comprising:
a user system including a user interface displaying items for purchase that is accessible through a user initiating a connection between a mobile device and a media screen that pushes data of items for purchase or available bets to said mobile device,
said user system including software stored on non-transitory computer readable media that recognizes and tags purchasable items in said media, wherein said user system displays items for purchase, and said user system including artificial intelligence (AI) integrated therein, and
said user system including a one-click purchase function allowing for secure and efficient purchases.

2. The media and shopping interface of claim 1, further including a recommendation search engine that delivers personalized content suggestions to said user with said AI.

3. The media and shopping interface of claim 2, wherein said recommendation search engine uses an algorithm chosen from the group consisting of collaborative filtering, content-based filtering, matrix factorization, hybrid models, nearest neighbors, deep learning, factorization machines, reinforcement learning, association rule learning, and graph-based algorithms.

4. The media and shopping interface of claim 1, further including an image search engine that retrieves images based on user queries with said AI.

5. The media and shopping interface of claim 4, wherein said image search engine uses an algorithm chosen from the group consisting of feature extraction, image indexing, similarity measurement, image retrieval, content-based image retrieval, semantic understanding, data augmentation, and machine learning models.

6. The media and shopping interface of claim 1, wherein said AI collects and delivers personalized information to advertisers to provide personalized ads to said user.

7. The media and shopping interface of claim 1, wherein said AI provides content recommendations to said user tailored to individual preferences.

8. The media and shopping interface of claim 1, wherein said AI creates personalized messages recommending content or products from said user to send to a second user.

9. The media and shopping interface of claim 1, wherein said AI integrates user interests with geo-tagging data to recommend relevant items in locations where items are offered for purchase.

10. The media and shopping interface of claim 1, wherein said AI enables direct polling and feedback mechanisms from shows and advertisements.

11. The media and shopping interface of claim 1, wherein said user system further includes an online betting module accessible by initiating a connection between the mobile device and a media screen that allows the first individual user to place bets on events, and wherein a bet can be placed before or during the events, and including an age verification mechanism.

12. The media and shopping interface of claim 11, wherein said AI tracks stats in sports and provides said stats to said user in said betting module.

13. The media and shopping interface of claim 1, wherein said AI tracks and integrates social media of leagues, teams, players, actors, and shows.

14. The media and shopping interface of claim 1, wherein said items for purchase are gifted to an individual.

15. The media and shopping interface of claim 1, wherein said software is further defined as software that recognizes and tags items available to purchase in said media by analyzing images within said media for pixel values and gradients to compare to images of items available for sale in order to correctly identify the items.

16. The media and shopping interface of claim 1, wherein said user system further includes:
a recording mechanism that records a desired portion of media upon activation by a first individual user who is not a content provider, the portion of media being less than a full media episode;
a friend request mechanism for sending and receiving friend requests between users to be approved to receive and share media and wherein the friend request mechanism suggests friends who have similar interests of the first individual user, and wherein the friends are searchable by information chosen from the group consisting of name, user name, gamer tag, telephone, address, and email;
a first user transmitter/receiver included in the user system that transmits the portion of media and a message generated by the first individual user regarding the portion of media to a second individual user who is not a content provider, the user system including the user interface having an input device and screen view that is generated by software stored on a memory device of the first user transmitter/receiver, the user system including a user profile generator interface and a store section for shopping for products and listing products for sale;
a confirmation mechanism that confirms that the second individual user is authorized to view the portion of media and a notification mechanism that notifies the first individual user if the second individual user is not authorized to receive the portion of media and notifies the second individual user that the portion of media cannot be received due to programming configuration subscribed to by the second individual user; and
a second user transmitter/receiver included in a second user system that receives the portion of media upon authorization of the second individual user; the second user system including a second user interface having an input device and screen view that is generated by software stored on a memory device of the second user transmitter/receiver, the second user system including a user profile generator interface and a store section for shopping for products and listing products for sale, wherein said store section includes software that recognizes and tags items available to purchase in said media.

17. The media and shopping interface of claim 1, wherein said user system further includes an online food ordering module accessible by initiating a connection between the mobile device and a media screen that allows the first individual user to order food from food advertised in a commercial, food advertised in an online ad, and food shown in a media program, wherein the online food ordering module interacts with an existing food ordering and delivery platform, wherein the first individual user can gift food and delivery to another user, and wherein said online food ordering module includes software that recognizes and tags food available to order in said media by analyzing images within said media for pixel values and gradients to compare to images of food items available for sale in order to correctly identify the food items.

18. The media and shopping interface of claim 1, wherein said user system is integrated in a smartphone or tablet and is accessible by using an application stored on non-transitory computer readable media, and wherein said user can select said item for purchase by a mechanism chosen from the group consisting of dragging and dropping said item into a shopping cart, circling said item on a touchscreen, and touching said item on a touchscreen.

19. The media and shopping interface of claim 1, further including an eye-tracking mechanism using sensors and cameras integrated into said smartphone or tablet to monitor and analyze where a gaze of said user is focused on a screen of said smartphone or tablet and that allows for purchasing items, gifting items, and placing bets with said user system.

20. The media and shopping interface of claim 16, wherein said media is chosen from the group consisting of program information, programming shows, movies, concerts, sporting events, online games, preset blocks of media, and commercials.

21. The media and shopping interface of claim 1, wherein said one-click purchase function securely stores payment and address information of said user on non-transitory computer readable media.

22. The media and shopping interface of claim 1, further including an integration module operated by AI for integration of said user system with external service providers.

23. The media and shopping interface of claim 22, wherein said external service providers are chosen from the group consisting of cable television providers, streaming services, betting services, gaming services, online food ordering services, and shopping services.

24. A method of shopping on media, including the steps of:
a user initiating a connection between a mobile device of a user system having a user interface with a media screen that pushes data of items for purchase or available bets to the mobile device;
artificial intelligence (AI) integrated in the system retrieving images based on user queries and software recognizing and assigning functional tags to purchasable items in the media, the functional tags not being visually displayed on a screen during media playback;
the user selecting an item in the media for purchase;
the user accessing a one-click purchase function in the user interface; and
the user purchasing the item seamlessly.

25. The method of claim 24, wherein said purchasing step is further defined as the user purchasing the item and gifting the item to an individual with stored user payment and address information on non-transitory computer readable media of the first user system.

26. The method of claim 24, wherein said software recognizing and tagging step is further defined as analyzing images within the media for pixel values and gradients to compare to images of items available for sale in order to correctly identify the items.

27. The method of claim 24, wherein the AI uses an algorithm chosen from the group consisting of feature extraction, image indexing, similarity measurement, image retrieval, content-based image retrieval, semantic understanding, data augmentation, and machine learning models.

28. The method of claim 24, further including the steps of:
a first individual user recording a portion of media and recording a message with the user interface on the user system;
transmitting the portion of media and message to a second individual user if the second individual user is authorized to view the portion of media; and
the second individual user viewing the portion of media and message with a second user interface on a second user system.

29. The method of claim 28, further including the step of the AI delivering personalized content suggestions to the user.

30. The method of claim 29, wherein the AI uses an algorithm chosen from the group consisting of collaborative filtering, content-based filtering, matrix factorization, hybrid models, nearest neighbors, deep learning, factorization machines, reinforcement learning, association rule learning, and graph-based algorithms.

31. The method of claim 28, further including the step of the AI collecting and delivering personalized information to advertisers to provide personalized ads to the user.

32. The method of claim 28, further including the step of the AI providing content recommendations to the user tailored to individual preferences.

33. The method of claim 28, further including the step of the AI creating personalized messages recommending content or products from the first individual user to send to the second individual user.

34. The method of claim 24, further including the step of the AI integrating user interests with geo-tagging data to recommend relevant items in locations where items are offered for purchase.

35. The method of claim 24, further including the step of the AI enabling direct polling and feedback mechanisms from shows and advertisements.

36. The method of claim 28, further including the step of the first individual user placing a bet on an event with an online betting module on the first user interface accessible by initiating a connection between the mobile device and a media screen, wherein the online betting module allows a bet to be placed before or during the event, and includes an age verification mechanism.

37. The method of claim 36, further including the step of the user placing a bet on an event in the media in real-time by activating an algorithm stored on non-transitory computer readable media on a user system, and freezing action in the media temporarily for the user while the bet is placed with the algorithm.

38. The method of claim 36, further including the step of the AI tracking statistics in sports and provides the statistics to the first individual user.

39. The method of claim 24, further including the step of the AI tracking and integrating social media of leagues, teams, players, actors, and shows.

40. The method of claim 28, further including the step of the user ordering food with an online food ordering module accessible by initiating a connection between the mobile device and a media screen, wherein the online food ordering module allows the first individual user to order food from food advertised in a commercial, food advertised in an online ad, and food shown in a media program, wherein the online food ordering module interacts with an existing food ordering and delivery platform, and wherein the first individual user can gift food and delivery to another user.

41. The method of claim 24, wherein each of the steps are performed using an application on a smartphone or tablet stored on non-transitory computer media.

42. The method of claim 24, wherein said purchasing step is further defined as a step chosen from the group consisting of using stored payment and address information securely stored on non-transitory computer-readable media within the user system and linking and using existing payment information of the user.

43. The method of claim 42, further including the step of monitoring and analyzing where a gaze of the user is focused on a screen of the smartphone or tablet using sensors and cameras integrated therein and allowing for purchasing items, gifting items, and placing bets with the user system through use of the user's eyes.

44. The method of claim 24, wherein said selecting step is further defined as a user performing an action chosen from the group consisting of dragging and dropping an item into a shopping cart, circling an item on a touchscreen, and touching an item on a touchscreen.

45. A method of integrating the media and shopping interface of claim 1 with an external service provider, including the steps of:
AI integrated in the media and shopping interface gathering integration requirements for the external service provider;
performing AI model development;
performing tool development and integration of the media shopping interface with the external service provider;
performing testing and validation; and
performing feedback and iteration.

46. The method of claim 45, wherein said gathering integration requirements step is further defined as the AI ingesting API spec of the external service provider and analyzing past integration projects to identify common challenges, data formats, and patterns.

47. The method of claim 45, wherein said performing AI model development step is further defined as the AI developing machine learning models to automate mapping and transformation of data fields between systems.

48. The method of claim 45, wherein said performing tool development and integration step is further defined as building an integration platform for data mapping, API adaptation, and error handling.

49. The method of claim 45, wherein said performing testing and validation step is further defined as validating the functionality and reliability of integrations with AI.

50. The method of claim 45, wherein said performing feedback and iteration step is further defined as gathering feedback from integration teams and stakeholders to refine AI models and tools.

51. The method of claim 45, wherein the external service provider is chosen from the group consisting of cable television providers, streaming services, betting services, gaming services, online food ordering services, and shopping services.

52. A method of shopping on media, including the steps of:
a user engaging in media playback on a user system's interface;
software recognizing and assigning functional tags to purchasable items in the media;
the user selecting an item in the media wherein interaction with the item does not disrupt or alter ongoing media playback;
the user accessing a one-click purchase function on the screen; and
the user purchasing the item seamlessly without viewing a third party seller's webpage using stored payment and address information securely stored on non-transitory computer-readable media within the user system.

53. A method of collecting and analyzing advertising data, including the steps of:
a user interacting with an advertisement on media within a user system;
the user system collecting data relating to the user's interaction with the advertisement and storing the data on non-transitory computer readable media;
AI on the user system analyzing the collected data; and
the user system providing the analyzed data to a third party.
